(19) United States
(12) Patent Application Publication
(10) Pub. No.: US 2026/0043681 A1
(43) Pub. Date: Feb. 12, 2026

(54) SERVER APPARATUS, INFORMATION PROCESSING SYSTEM, PROGRAM AND METHOD

(71) Applicants: Tomoya HIROKAWA, Tokyo (JP); Takuto YOSHIDA, Tokyo (JP); Yuichi INOUE, Tokyo (JP); Megumi SAWAMURA, Tokyo (JP); Ryuichi TAKANO, Tokyo (JP)

(72) Inventors: Tomoya HIROKAWA, Tokyo (JP); Takuto YOSHIDA, Tokyo (JP); Yuichi INOUE, Tokyo (JP); Megumi SAWAMURA, Tokyo (JP); Ryuichi TAKANO, Tokyo (JP)

(21) Appl. No.: 19/295,883

(22) Filed: Aug. 11, 2025

(30) Foreign Application Priority Data
Aug. 9, 2024 (JP) 2024-134127
Nov. 18, 2024 (JP) 2024-200791

(51) Int. Cl. G01D 21/02; G06N 20/00

(52) U.S. Cl. CPC G01D 21/02; G06N 20/00

(57) ABSTRACT

A server apparatus communicates with an AI based response device to present users with an AI generated introduction to a physical space. The server apparatus receives sensor data from a predetermined space, generates a prompt containing environmental information based on that data and requesting descriptive text, sends the prompt to the AI device, and outputs a screen displaying the AI generated introduction. The system may further include human-detection sensors, prompt generation for space analysis and reporting, and a display apparatus to render the screen.

### CROSS-REFERENCE TO RELATED APPLICATIONS

This patent application is based on and claims priority pursuant to 35 U.S.C. § 119 (a) to Japanese Patent Application No. JP 2024-134127, filed on Aug. 9, 2024 in the Japan Patent Office and Japanese Patent Application No. JP 2024-200791, filed on Nov. 18, 2024 in the Japan Patent Office, the entire disclosure of which are hereby incorporated by reference in their entirety.

### BACKGROUND

### Technical Field

Embodiments of this disclosure relate to a server apparatus, an information processing system, a program, and a method.

### Related Art

An information processing technology is known that in a so called free-address office environment, where users' seats are not fixed, it is known to select one or more candidate seats within a comfortable temperature range for each user based on (i) ambient temperature data measured per seat or seat area, and (ii) each user's personal comfort temperature range data.

### SUMMARY

In accordance with one or more embodiments of the present disclosure, a server apparatus for communicating with a device that generates artificial intelligence (AI) based responses, comprising: receiving, a data measured by a sensor installed in a predetermined space; generating, as a prompt including environmental information based on the data, a request to create descriptive text introducing the predetermined space; transmitting, the generated prompt to the device; and outputting, on a screen, the descriptive text generated by the device in response to the prompt.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1: A diagram showing an example of a system configuration of an information processing system.

FIG. 2: A diagram showing an example of a hardware configuration of a server apparatus included in the information processing system.

FIG. 3: A diagram showing a hardware configuration of a terminal apparatus included in the information processing system.

FIG. 4: A diagram showing a hardware configuration of a display device included in the information processing system.

FIG. 5: A diagram illustrating the functional configuration of each device included in the information processing system.

FIG. 6: A diagram showing an example of a characteristic information storage unit.

FIG. 7: A diagram showing an example of an environmental information storage unit.

FIG. 8A: A diagram showing a first example of a descriptive-text history storage unit.

FIG. 8B: A diagram showing a second example of a descriptive-text history storage unit.

FIG. 9: A diagram showing an example of a report storage unit.

FIG. 10: A first sequence diagram illustrating operation of the information processing system.

FIG. 11: A second sequence diagram illustrating operation of the information processing system.

FIG. 12: A third sequence diagram illustrating operation of the information processing system.

FIG. 13: A fourth sequence diagram illustrating operation of the information processing system.

FIG. 14: A fifth sequence diagram illustrating operation of the information processing system.

FIG. 15: A sixth sequence diagram illustrating operation of the information processing system.

FIG. 16: An example of a characteristic-information input screen.

FIG. 17: A first example of an introduction screen displayed on the terminal apparatus.

FIG. 18: A second example of an introduction screen displayed on the terminal apparatus.

FIG. 19: A third example of an introduction screen displayed on the terminal apparatus.

FIG. 20: A fourth example of an introduction screen displayed on the terminal apparatus.

FIG. 21: A first example of a report screen.

FIG. 22: A second example of a report screen.

FIG. 23: A third example of a report screen.

FIG. 24: A first example of a detailed screen.

FIG. 25: A second example of a detailed screen.

FIG. 26: A third example of a detailed screen.

FIG. 27: A fourth example of a detailed screen.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result. The present invention encompasses various modifications to each of the examples and embodiments discussed herein. According to the invention, one or more features described above in one embodiment or example can be equally applied to another embodiment or example described above. The features of one or more embodiments or examples described above can be combined into each of the embodiments or examples described above. Any full or partial combination of one or more embodiment or examples of the invention is also part of the invention. Referring now to the drawings, embodiments of the present disclosure are described in detail below. As used herein, the singular forms “a,” “an,” and “the” are intended to include the plural forms as well, unless the context clearly indicates otherwise.

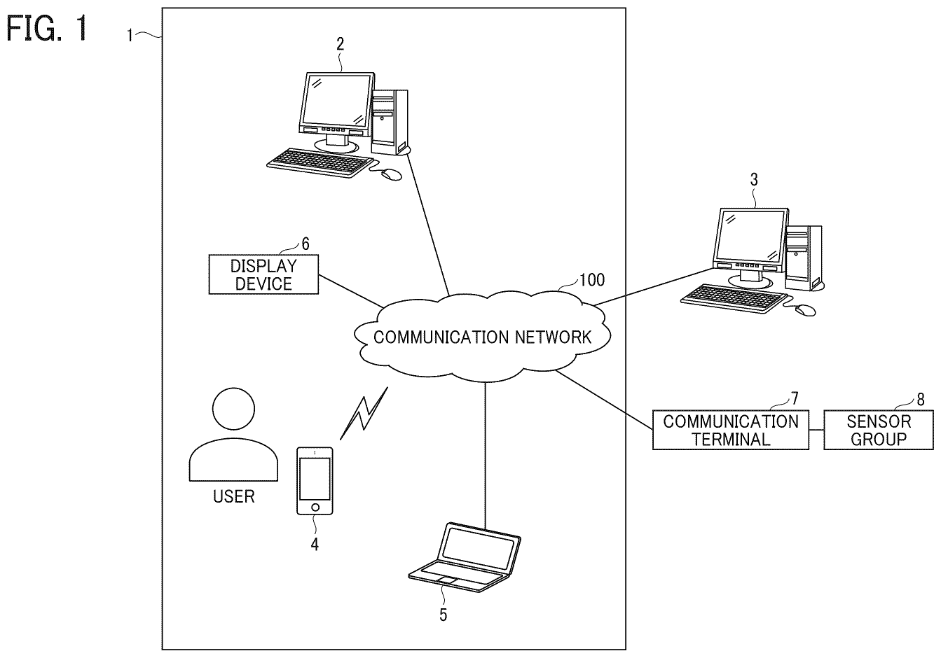

With reference to the accompanying drawings, embodiments of the present disclosure will be described below. FIG. 1 illustrates an example of a system configuration of an information processing system.

The information processing system 1 of the one or more embodiments displays a screen that introduces the environment of a user-selected space among multiple subdivided spaces. The multiple subdivided spaces include, for example, spaces inside a building, rooms, and partitions within a room.

In the one or more embodiments, the subdivided spaces are spaces within a free-address office environment where the user's work seat is not fixed. The information processing system 1 of the one or more embodiments uses AI to output a screen that introduces the environment of the user-selected space in the free-address office environment. Note that the free-address office environment is merely one example of a subdivided space and the invention is not limited thereto.

By doing so, the user can be presented with an introductory text that describes the environment of the selected space.

The information processing system 1 of the one or more embodiments includes a server apparatus 2, a terminal apparatus 4, an administrator terminal apparatus 5, and a display apparatus 6. Note that throughout the specification, the term “apparatus” is interchangeable with the term “device,” hence the use of “device” in the figures. The server apparatus 2, the terminal apparatus 4, the administrator terminal apparatus 5, and the display apparatus 6 are all connected via a communication network 100. Further, the information processing system 1 is also connected, via the communication network 100, to a server apparatus 3 and to a communication terminal 7.

The server apparatus 3 generates and outputs an AI-based response when it receives a prompt from the information processing system 1. Here, “AI” stands for Artificial Intelligence. A large language model (LLM) is one example of such AI, but other forms of AI may be used.

The communication terminal 7 may be provided in a building equipped with a free-address office environment. The communication terminal 7 is connected, by wired or wireless means, to a sensor group 8 arranged in each subdivided space of the free-address office environment. When the communication terminal 7 receives sensor values output by the sensor group 8, it transmits those sensor values to the server apparatus 2 via the communication network 100. In the one or more embodiments, “sensor values” refer to data measured by sensors installed in a given space.

The sensor group 8 comprises multiple sensors, including a temperature sensor for measuring ambient temperature, a humidity sensor, a carbon-dioxide concentration sensor, a noise sensor, a solar-irradiance sensor, a barometric-pressure sensor, and an illuminance sensor. In addition, the sensor group 8 includes an imaging device that detects occupants via image recognition. The sensors are not limited to these examples; other types of sensors may also be included.

Each sensor value output by the sensor group 8 represents example environmental information of the space. Such sensor values may be associated with information identifying the space in which the sensor is installed and with a timestamp indicating when the value was measured.

In the information processing system 1 of the one or more embodiments, when the server apparatus 2 receives various sensor values from the sensor group 8 via the communication terminal 7, it generates environmental information for each space by linking the sensor values. The server apparatus 2 then generates a prompt-including the environmental information and a request to create descriptive text introducing the space based on that information—and transmits this prompt to the server apparatus 3.

The server apparatus 2 receives text data from the server apparatus 3 that represents the introductory text output in response to the prompt. It stores (e.g., organizes) this text data by space. In the following description, this text data may simply be referred to as “introductory text.”

The terminal apparatus 4 is a portable device held by a user utilizing the services of the information processing system 1. For example, the terminal apparatus 4 may be any devices, such as a smartphone, a tablet, a wearable device (e.g., smart watch), a laptop and the like, but not limited thereto.

The administrator terminal apparatus 5 is a device used by an administrator of the information processing system 1. For example, it may be used to input information about a building in which the system's services are deployed.

The display apparatus 6 is used by visitors to the building where the system's services are deployed. It may be, for example, an electronic blackboard, projector, large display, tablet, or similar electronic medium installed on each floor. In the one or more embodiments, an electronic blackboard is exemplified.

In the information processing system 1 of the one or more embodiments, when a space is selected in accordance with a user's operation on the terminal apparatus 4 or the display apparatus 6, a screen containing the introductory text for the selected space is displayed. In other words, the server apparatus 2 outputs information to the terminal apparatus 4 or the display apparatus 6 that causes them to present a screen based on the introductory text generated from the environmental information.

By doing so, the user can be presented with introductory text that includes both the environment of the selected space and recommended information for using that space.

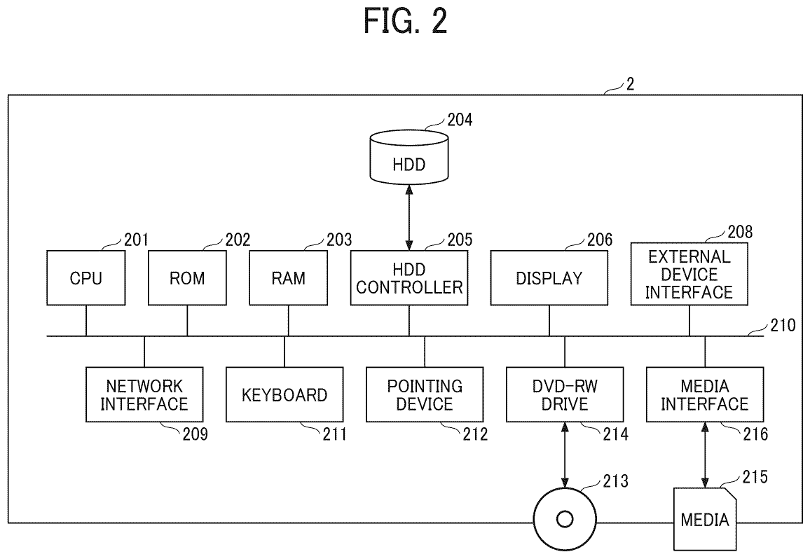

Next, with reference to FIGS. 2 to 4, the hardware configurations of the devices in the information processing system 1 of the one or more embodiments will be described.

FIG. 2 illustrates an example hardware configuration of the server apparatus. As shown, server apparatus 2 is constructed from a computer including a CPU 201, ROM 202, RAM 203, hard disk 204, HDD controller 205, display 206, external-device interface 208, network interface 209, data bus 210, keyboard 211, pointing device 212, DVD-RW drive 214, and media interface 216. Display 206 exemplifies the display unit. The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), conventional circuitry and/or combinations thereof which are programmed, using one or more programs stored in one or more memories, or otherwise configured to perform the disclosed functionality. Processors and controllers are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

Of these components, CPU 201 controls overall operation of the server apparatus 2. ROM 202 stores programs such as an initial program loader (IPL). RAM 203 serves as a workspace for the CPU. Hard disk 204 stores various programs and data. HDD controller 205 manages reading from and writing to the hard disk in accordance with CPU commands. Display 206 shows cursors, menus, windows, text, images, and other information. External-device interface 208 connects peripheral devices, such as USB memory or printers. Network interface 209 enables data communication via the communication network 100. Data bus 210 electrically connects the CPU and other components.

Keyboard 211 provides keys for inputting characters, numbers, and commands. Pointing device 212 enables selection and execution of commands, target selection, and cursor movement. DVD-RW drive 214 reads from and writes to removable media, such as DVD-RW. Media interface 216 reads from and writes to storage media, such as flash memory.

The administrator terminal apparatus 5 may share the same hardware configuration as either the server apparatus 2 or the terminal apparatus 4.

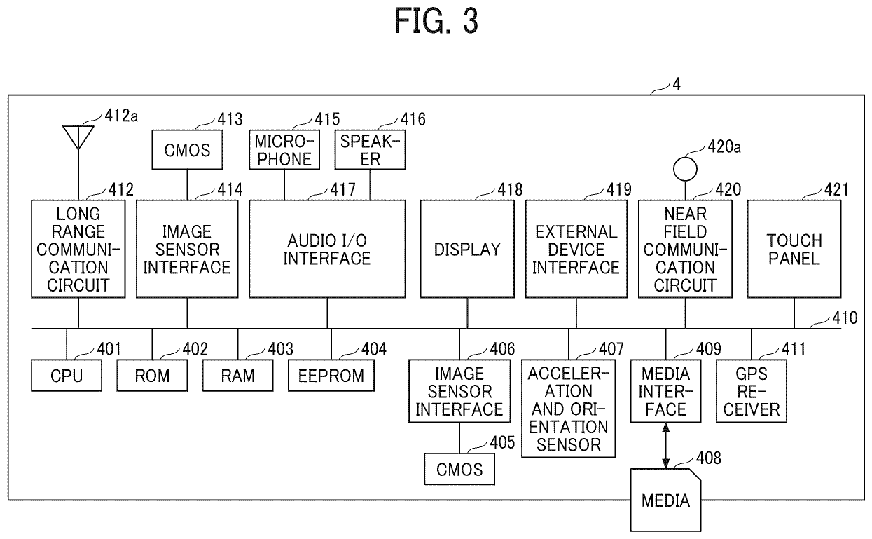

FIG. 3 shows an example hardware configuration of the terminal apparatus 4. As illustrated, terminal apparatus 4 includes a CPU 401, ROM 402, RAM 403, EEPROM 404, CMOS sensor 405, imaging-element interface 406, acceleration/orientation sensor 407, media interface 409, and GPS receiver 411.

Of these, CPU 401 controls the overall operation of terminal apparatus 4. ROM 402 stores programs for driving the CPU. RAM 403 serves as the CPU's workspace. EEPROM 404 reads and writes various program data under CPU control. CMOS sensor 405 captures images (mainly selfies) under CPU control; a CCD sensor may be used instead. Imaging-element interface 406 drives the CMOS sensor. Acceleration/orientation sensor 407 includes sensors, such as an electronic compass and accelerometer. Media interface 409 reads and writes data to storage media, such as flash memory. GPS receiver 411 receives GPS signals from satellites.

Terminal apparatus 4 further includes a long-distance communication circuit 412, CMOS sensor 413, imaging-element interface 414, microphone 415, speaker 416, audio I/O interface 417, display 418, external-device connection interface 419, short-distance communication circuit 420 (with antenna 420a), and touch panel 421. Display 418 is one example of a display unit.

Of these, long-distance communication circuit 412 is a circuit for communicating with other devices via communication network 100. CMOS sensor 413 is an internal imaging means that captures an object under control of CPU 401 to obtain image data. Imaging-element interface 414 controls driving of CMOS sensor 413. Microphone 415 converts sound into electrical signals. Speaker 416 converts electrical signals into physical vibrations to produce audio, such as music or voice. Audio I/O interface 417 processes audio input/output between CPU 401 and microphone 415/speaker 416. Display 418 is a display means, such as an LCD or organic EL panel that shows images and icons. External-device connection interface 419 provides connections for various external devices. Short-distance communication circuit 420 is a communication circuit, such as NFC (Near Field Communication) or Bluetooth®, and antenna 420a is its antenna. Touch panel 421 is an input means whereby a user operates terminal apparatus 4 by touching display 418.

Terminal apparatus 4 also includes bus line 410, which is an address bus or data bus electrically connecting components, such as CPU 401 shown in FIG. 3.

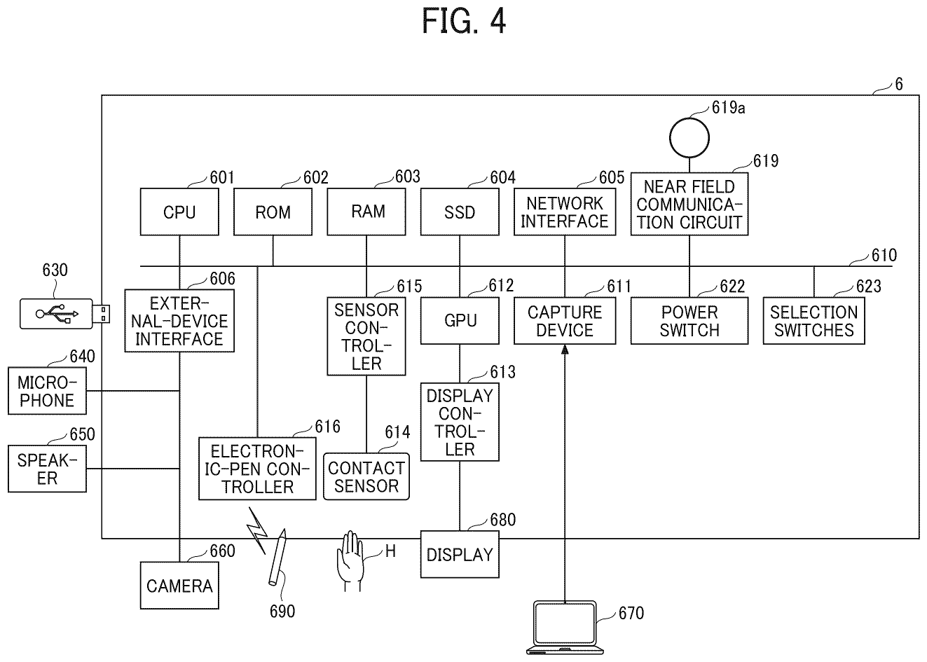

FIG. 4 is a hardware configuration diagram of display apparatus 6 of the information processing system. In the one or more embodiments, display apparatus 6 is exemplified as an electronic blackboard. As shown in FIG. 4, electronic blackboard 6 includes CPU 601, ROM 602, RAM 603, SSD 604, network interface 605, and external-device connection interface 606.

Of these, CPU 601 controls overall operation of display apparatus 6. ROM 602 stores programs, such as the initial program loader (IPL) used to drive CPU 601. RAM 603 serves as a workspace for CPU 601. SSD 604 stores programs and data for the electronic blackboard. Network interface 605 controls communication with communication network 100. External-device connection interface 606 provides connections for various external devices, such as USB memory 630 or external peripherals (e.g., microphone 640, speaker 650, camera 660).

Display apparatus 6 further includes capture device 611, GPU 612, display controller 613, touch sensor 614, sensor controller 615, electronic-pen controller 616, short-distance communication circuit 619 (with antenna 619a), power switch 622, and selection switches 623.

Of these, capture device 611 displays static or moving images on an external PC display 670. GPU 612 is a semiconductor chip specialized for graphics. Display controller 613 controls and manages screen display to output images from GPU 612 to display 680. Touch sensor 614 detects contact of electronic pen 690 or a user's hand on display 680. Sensor controller 615 controls processing of touch sensor 614. Touch sensor 614 employs, for example, an infrared-beam interruption method in which paired emitters and receivers at the top edges of display 680 project infrared beams in parallel across the display; reflected beams return along the same paths and are detected, and interruptions determine contact coordinates. Electronic-pen controller 616 communicates with electronic pen 690 to detect pen-tip or pen-butt touches. Short-distance communication circuit 619 is implemented by NFC, Bluetooth®, etc. Power switch 622 toggles power ON/OFF for electronic blackboard 6. Selection switches 623 adjust display settings, such as brightness and color tone.

Display apparatus 6 also includes bus line 610, an address/data bus electrically connecting components, such as CPU 601 shown in FIG. 4.

Note that touch sensor 614 is not limited to infrared interruption; various touch-panel technologies may be used, such as capacitive sensing (detecting capacitance changes), resistive membranes (detecting voltage changes), or electromagnetic induction (detecting induced currents). Electronic-pen controller 616 may also detect contact on any part of electronic pen 690, including the grip portion or other surfaces.

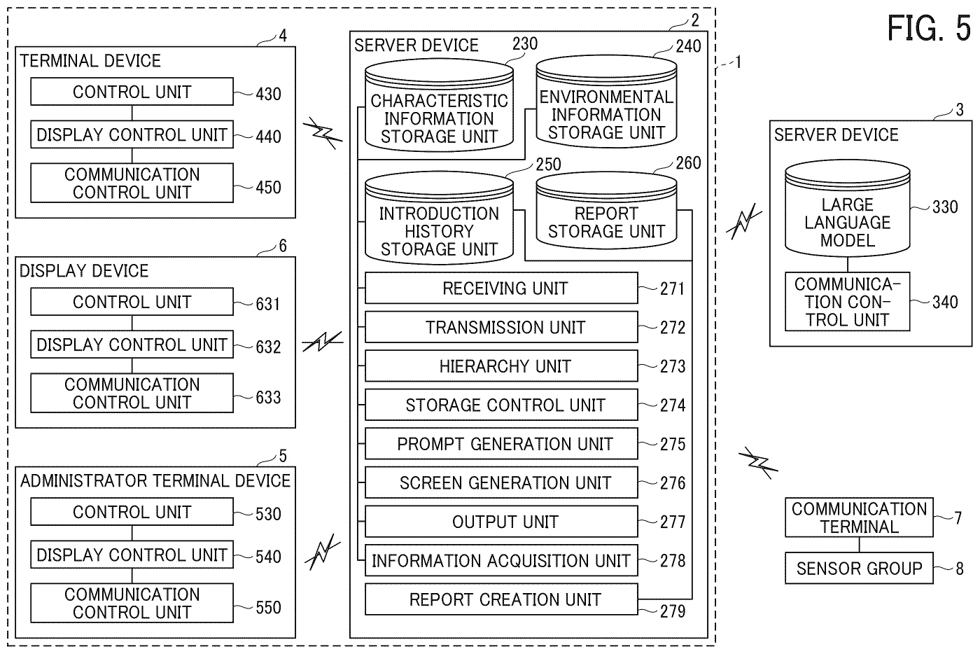

Next, with reference to FIG. 5, the functional configuration of each device in information processing system 1 will be described. FIG. 5 illustrates the functional blocks of the system.

First, the functional configuration of server apparatus 2 is described. In the one or more embodiments, server apparatus 2 includes characteristic-information storage unit 230, environmental-information storage unit 240, descriptive-text-history storage unit 250, and report storage unit 260. These may be realized by HDD 204 or other storage devices.

Characteristic-information storage unit 230 stores information, such as maps of deployed buildings and per-space characteristic data. Environmental-information storage unit 240 stores environmental information for each space, including sensor values output by sensors installed in those spaces—i.e., data measured by the sensors.

Descriptive-text-history storage unit 250 stores history of descriptive texts for each space. Report storage unit 260 stores report information showing analysis results of each space's environment based on the descriptive-text history, and so on. Details of these units are described below.

Server apparatus 2 further includes reception unit 271, transmission unit 272, hierarchy-forming unit 273, storage-control unit 274, prompt-generation unit 275, screen-generation unit 276, output unit 277, information-acquisition unit 278, and report-creation unit 279. Each block is implemented by CPU 201 executing programs stored in ROM 202.

Reception unit 271 receives various data sent to server apparatus 2. Specifically, it receives sensor values output from sensors in sensor group 8 via communication terminal 7—that is, data measured by sensors installed in respective spaces.

Reception unit 271 also receives descriptive text output by server apparatus 3, and characteristic information input via administrator terminal apparatus 5.

Transmission unit 272 transmits various data from server apparatus 2 to external devices. For example, it sends prompts generated by prompt-generation unit 275 to server apparatus 3.

Hierarchy Forming Unit 273 converts the sensor values received by Reception Unit 271 into hierarchical information and includes that in the environmental information. Specifically, Hierarchy Forming Unit 273 holds threshold values for each type of sensor value and, based on those thresholds, replaces the raw sensor readings with intuitive, human-readable descriptions of the environment.

Storage Control Unit 274 stores various kinds of information into their corresponding storage units. In particular, when Reception Unit 271 receives characteristic information, Storage Control Unit 274 stores it in Characteristic-Information Storage Unit 230. When Reception Unit 271 receives sensor values from Communication Terminal 7, Storage Control Unit 274 stores those values in Environmental-Information Storage Unit 240. Further, when Reception Unit 271 receives an introductory text from Server Apparatus 3, Storage Control Unit 274 stores it in Descriptive-Text-History Storage Unit 250.

Prompt Generation Unit 275 generates a prompt to be sent to Server Apparatus 3 when a space within the building is selected. Concretely, Prompt Generation Unit 275 creates a prompt that includes the environmental information associated with the selected space and a request to generate introductory text for that space. Moreover, based on the characteristic information associated with the selected space, it may generate a prompt that includes both the characteristic information and environmental information, along with any conditions for and the request to create the introductory text. In the one or more embodiments, Prompt Generation Unit 275 may split a single request into multiple prompts.

In the one or more embodiments, Prompt Generation Unit 275 may periodically generate prompts requesting creation of introductory text for each space in the building. In that case, Transmission Unit 272 sends each generated prompt to Server Apparatus 3, and Storage Control Unit 274 stores each received introductory text into Descriptive-Text-History Storage Unit 250.

Also, Prompt Generation Unit 275 may generate a prompt including a request to create introductory text for a space whenever a user at Terminal Apparatus 4 or Display Apparatus 6 selects a space in the building. In that case, Storage Control Unit 274 stores the introductory text received from Server Apparatus 3 into Descriptive-Text-History Storage Unit 250.

Screen Generation Unit 276 generates display data for a screen that includes the introductory text output by Server Apparatus 3 in response to the prompt created by Prompt Generation Unit 275.

Output Unit 277 outputs the screen data generated by Screen Generation Unit 276 to Terminal Apparatus 4 or Display Apparatus 6.

Information-Acquisition Unit 278 obtains external information-such as weather data—from servers or other external sources outside Information Processing System 1.

Report Creation Unit 279 refers to Descriptive-Text-History Storage Unit 250 to create report information for each space. The text data included in the report may be examples of the introductory texts.

Next, the functions of Terminal Apparatus 4 are described. Terminal Apparatus 4 includes Control Unit 430, Display Control Unit 440, and Communication Control Unit 450. Control Unit 430 controls the operations of Terminal Apparatus 4. Display Control Unit 440 manages the screens displayed on its display. Communication Control Unit 450 handles communications with Server Apparatus 2 and other devices.

Next, the functions of Administrator Terminal Apparatus 5 are described. Administrator Terminal Apparatus 5 includes Control Unit 530, Display Control Unit 540, and Communication Control Unit 550. Control Unit 530 manages its operations. Display Control Unit 540 controls its display screens. Communication Control Unit 550 handles communication with Server Apparatus 2 and other devices.

Next, the functions of Server Apparatus 3 are described. Server Apparatus 3 includes Storage Unit 330 and Communication Control Unit 340. Server Apparatus 3 performs AI-based responses. Storage Unit 330 stores a large language model, which corresponds to the AI. Communication Control Unit 340, implemented by the CPU and communication interface, communicates with Server Apparatus 2 via Communication Network 100.

The large language model is a computer language model composed of an artificial neural network with many parameters, generated by training on vast amounts of unlabeled text data.

The large language model is sufficiently trained—using methods, such as next-sentence prediction (determining whether two sentences are consecutive) and masked-language modeling (predicting masked words from context)—to capture much of human syntax and semantics.

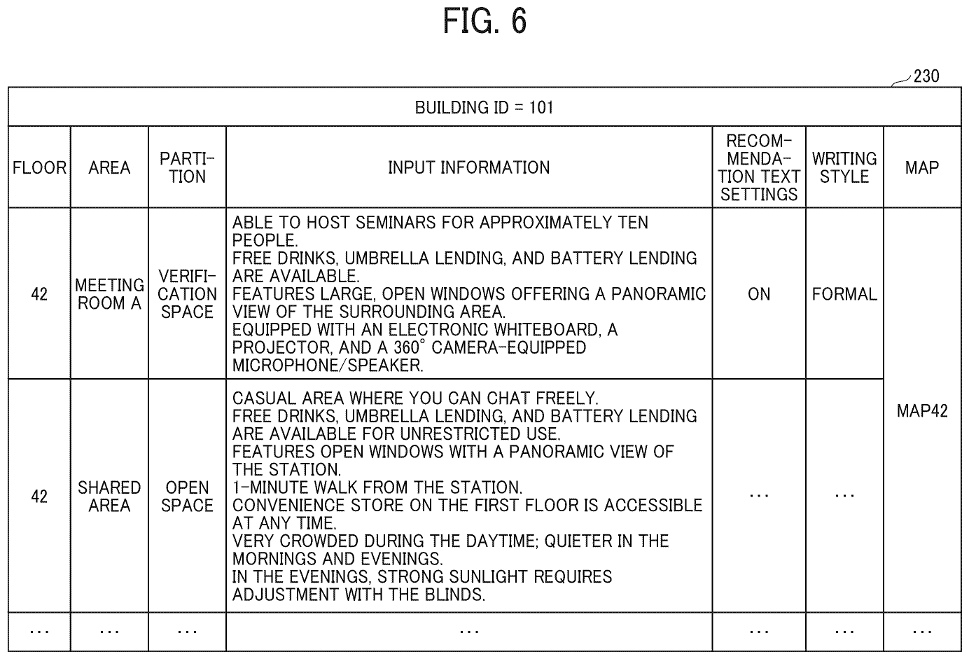

Next, with reference to FIGS. 6-9, the storage units of Server Apparatus 2 are described. FIG. 6 illustrates an example of Characteristic-Information Storage Unit 230.

The characteristic information stored in Characteristic-Information Storage Unit 230 of the one or more embodiments is information per building and relates to predefined spaces. As shown in FIG. 6, each record includes fields, such as Building ID, Floor, Area, Section, Input Information, Recommendation-Text Setting, Writing Style, and Map. The Building ID field associates the building identifier with the other fields. Note that additional fields beyond those in FIG. 6 may be included.

In the one or more embodiments, the “Recommendation-Text Setting” and “Writing Style” fields are part of the characteristic information, but they may alternatively be stored in separate storage units. The characteristic information may be input via Administrator Terminal Apparatus 5 or obtained automatically—for example, via image recognition of space photographs stored in Characteristic-Information Storage Unit 230.

The “Building ID” field uniquely identifies a building. The “Floor” field indicates the story within the building. The “Area” field identifies a room subdivided within that floor. The “Section” field further subdivides the area into smaller spaces. The “Input Information” field contains data entered via Administrator Terminal Apparatus 5.

The “Recommendation-Text Setting” field indicates whether to include recommended usage information in the introductory text. When set to “Enabled,” the introductory text for that space will include suggestions for users. When set to “Disabled,” such suggestions are omitted. Thus, the Recommendation-Text Setting is an example of a condition for generating the introductory text.

Recommended usage information may include actions or hints to improve user satisfaction, prompts to encourage user behavior, or suggested activities within the space.

The “Writing Style” field specifies the tone of the introductory text. The “Map” field indicates the storage location of floor-plan map data for the specified floor; alternatively, it may contain the map data itself.

In the example of FIG. 6, it can be seen that there is a conference room A and a shared area on the 42nd floor of a building identified by building ID “101”, a verification space is provided inside conference room A, and an open space is provided within the shared area. In addition, text data, such as “Seminars for about 10 people can be held. Free drinks, umbrella rentals, and battery rentals are available . . . ” has been entered as input information for the verification space, the recommended sentence setting is “Yes”, and the writing style is set to “polite”.

In addition, although not shown in FIG. 6, the characteristic information may include, as information items, the name of the building identified by the building ID, the country or region in which the building is located, etc.

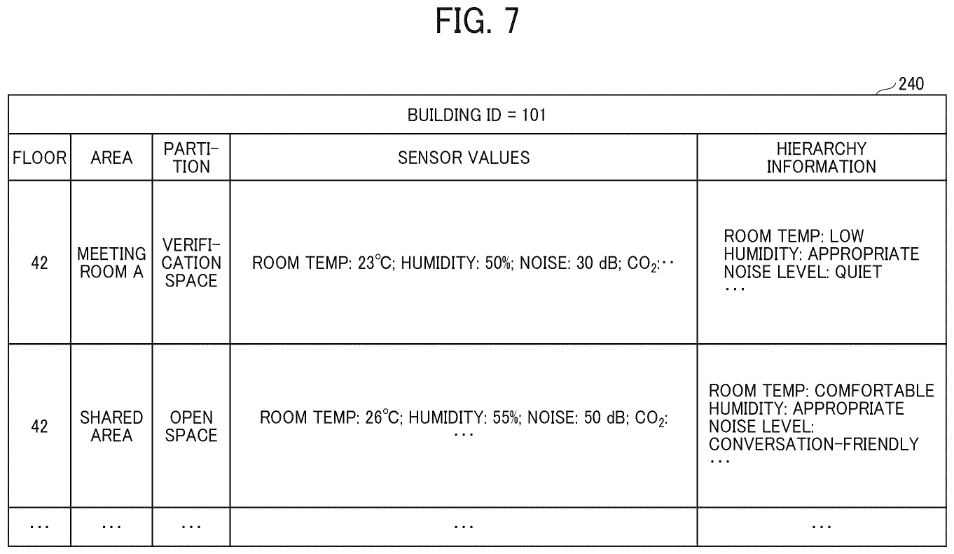

FIG. 7 is a diagram illustrating one example of the environmental information storage unit. In the one or more embodiments, environmental information stored in environmental information storage unit 240 is stored on a per-building basis. The environmental information includes, as data items, building ID, floor, area, partition, sensor values, hierarchical information, and the like, with the “building ID” item being associated with each of the other items. The items included in the environmental information are not limited to those shown in FIG. 7 and may include additional items.

The value of the “sensor values” item corresponds to sensor values output from various sensors installed in the space specified by the building ID, floor, area, and partition. In the one or more embodiments, the “sensor values” item may be Comma Separated Values (CSV) data indicating the sensor values acquired from the various sensors, or data in the original format output by the sensors.

In the one or more embodiments, by storing the sensor values acquired from the various sensors as CSV data, it is possible to collectively manage the sensor values on a per-building basis. Moreover, by holding the sensor values as CSV data, the sensor values obtained from sensor group 8 can be utilized by other systems.

The value of the “hierarchical information” item is information that replaces the environment indicated by the sensor values with terms that are more intuitively understandable to a human. The hierarchical information is generated by hierarchical unit 273. Details of the processing performed by hierarchical unit 273 will be described later.

In the example of FIG. 7, the verification space located inside Conference Room A on the 42nd floor of the building identified by building ID “101” is indicated as having a low temperature, proper humidity, and a quiet environment. Also, in FIG. 7, the open space on the 42nd floor of the building identified by building ID “101” is indicated as having a comfortable temperature, proper humidity, and an environment conducive to conversation.

In the one or more embodiments, by including, in the environmental information, both the sensor values from the various sensors installed in a space and hierarchical information that translates those sensor values into human-friendly descriptions, response text generated in response to prompts containing the environmental information can be rendered in a manner that is more readily comprehensible to users.

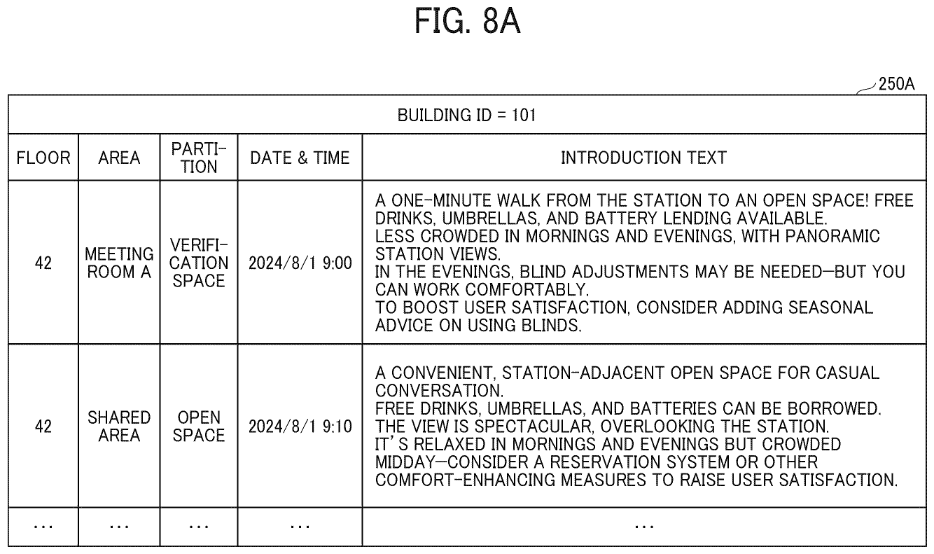

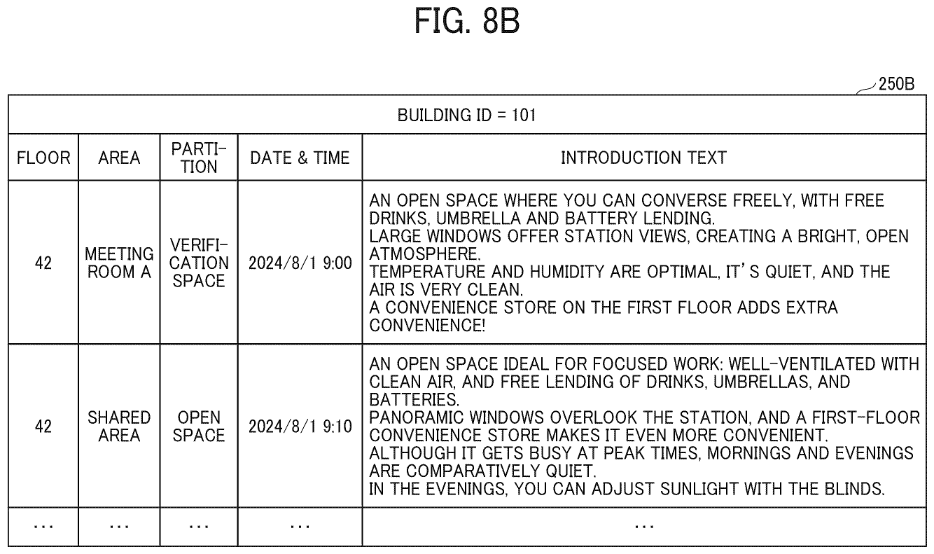

Next, with reference to FIGS. 8A and 8B, the introduction text history storage unit 250 will be described. FIG. 8A is a first diagram illustrating one example of the introduction text history storage unit. In FIG. 8A, when the open space on the 42nd floor of the building identified by building ID “101” is selected as the space for which creation of an introduction text is requested, and when the “recommended sentence setting” item in the characteristic information corresponding to that space is set to “present,” an example of the introduction text history information—including introduction texts acquired from server apparatus 3—is shown.

In the one or more embodiments, the introduction text history information includes, as data items, building ID, floor, area, partition, date/time, introduction text, and the like, with the “building ID” item being associated with each of the other items. The data items included in the introduction text history information are not limited to those shown in FIG. 8A and may include additional items.

The value of the “date/time” item indicates the date and time at which reception unit 271 of server apparatus 2 received an introduction text from server apparatus 3. Alternatively, the “date/time” value may indicate the date and time at which server apparatus 2 transmitted the prompt requesting creation of an introduction text.

The value of the “introduction text” item is the text data representing the introduction text acquired by reception unit 271 of server apparatus 2 from server apparatus 3.

In FIG. 8A, the introduction text received from server apparatus 3 at 9:00 on Aug. 1, 2024 is an example for which the “text style” item in the characteristic information is set to “formal” and the “recommended sentence setting” item is set to “present.” This introduction text includes, for example:
“An open space one minute from the station. Free drinks, umbrellas, and battery lending are available. It is uncrowded in the morning and evening, and offers a panoramic view of the station from the windows. Although scheduling adjustments may be required in the evening, the environment is comfortable for work.”

This introduction text further includes suggested actions aimed at improving user satisfaction, for example:
“To enhance user satisfaction, it may be beneficial to provide seasonal advice on using the blinds.”

Also in FIG. 8A, the introduction text received at 9:10 on Aug. 1, 2024 is another example for which the “text style” item is set to “formal” and the “recommended sentence setting” item is set to “present.” This introduction text includes, for example:
“A convenient station-front open space that facilitates easy conversation. Free drinks, umbrellas, and battery lending are available. The view from the windows is superb, overlooking the station. It is relaxed in the morning and evening but crowded during the daytime, so caution is advised.”

This introduction text additionally includes recommendations for enhancing user satisfaction, for example:
“To further improve comfort, implementing a reservation system for peak hours and additional comfort-enhancing measures is recommended.”

FIG. 8B is a second diagram illustrating one example of the introduction text history storage unit. In FIG. 8B, when the open space on the 42nd floor of the building identified by building ID “101” is selected and the “recommended sentence setting” item in the corresponding characteristic information is set to “absent,” an example of the introduction text history information—comprising introduction texts acquired from server apparatus 3 under that setting—is shown.

In FIG. 8B, the introduction text received from server apparatus 3 at 9:00 on Aug. 2, 2024 is an example for which the “text style” item is set to “formal” and the “recommended sentence setting” item is set to “absent.” This introduction text includes messages based on the “input information” item but omits suggestions for space usage.

Also in FIG. 8B, the introduction text received at 9:10 on Aug. 2, 2024 is another example for which the “text style” item is set to “formal” and the “recommended sentence setting” item is set to “absent.” This introduction text likewise includes messages based on the “input information” item and omits usage recommendations.

In the one or more embodiments, by setting the “recommended sentence setting” item to “absent,” the character count of the introduction text can be reduced. Accordingly, depending on the display area size, font settings, or user evaluations of the introduction text, the number of characters and types of information displayed can be adjusted.

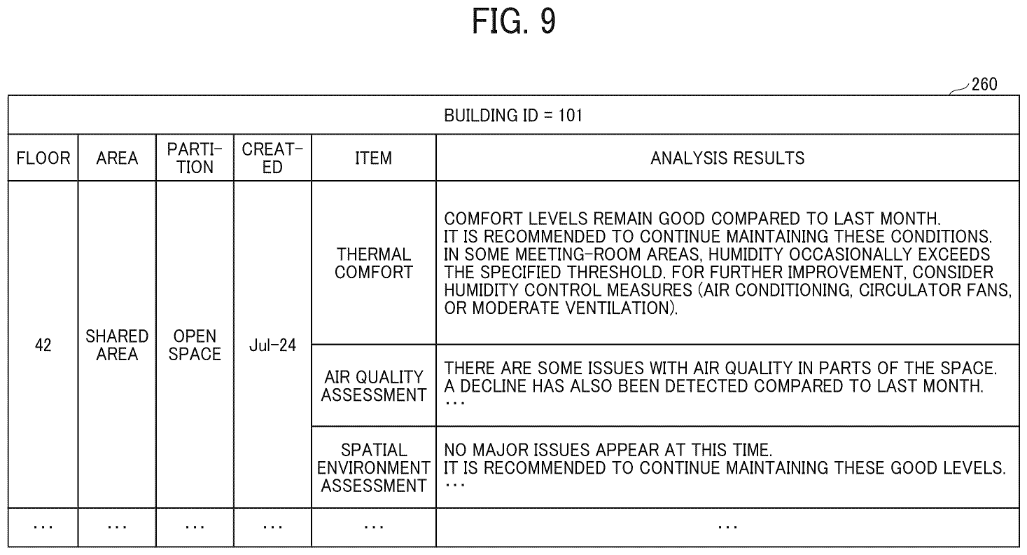

FIG. 9 is a diagram illustrating one example of the report storage unit. Report information stored in report storage unit 260 includes, as data items, building ID, floor, area, partition, creation time, analysis items, analysis results, and the like, with the “building ID” item being associated with each of the other items. The data items included in the report information are not limited to those shown in FIG. 9 and may include additional items.

The value of the “creation time” item indicates the date on which server apparatus 2 acquired the report information from server apparatus 3. The “creation time” value may also include information indicating the period subject to analysis.

The value of the “analysis items” item indicates the items to be analyzed, and the value of the “analysis results” item indicates text data representing the analysis results acquired by server apparatus 2 from server apparatus 3.

In the example of FIG. 9, the report information relating to the open space on the forty-second floor of the building identified by building ID “101” is created on July 24, and it can be seen that the analysis items of this report information include thermal comfort, air evaluation, space evaluation, and the like.

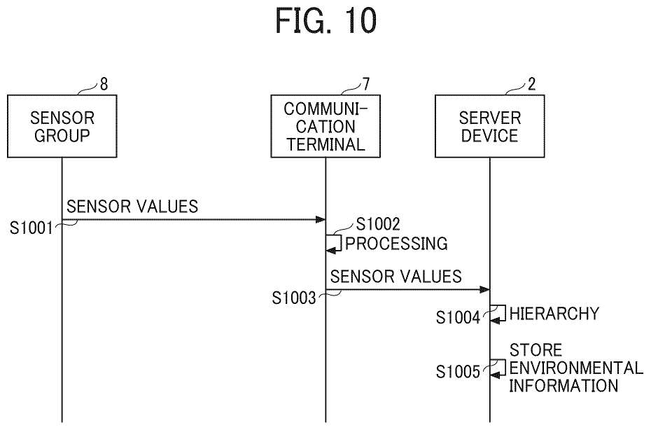

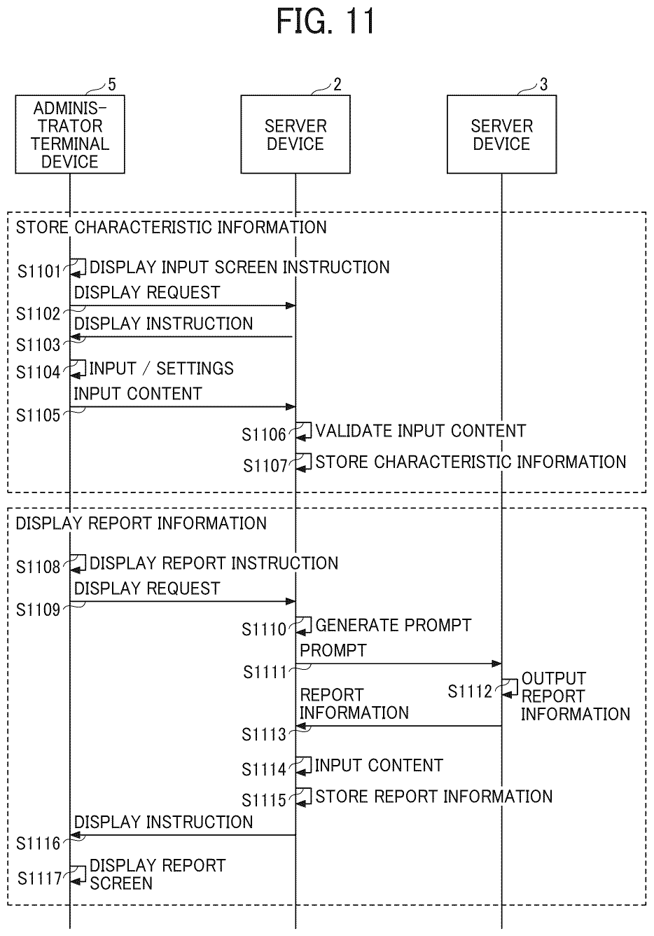

Next, with reference to FIGS. 10 and 11, the operation of the information processing system 1 of the one or more embodiments will be described.

FIG. 10 is a first sequence diagram illustrating an operation of the information processing system. In FIG. 10, an operation in which the server apparatus 2 stores environmental information in the environmental information storage unit 240 is described.

In the information processing system 1 of the one or more embodiments, each sensor included in sensor group 8 transmits sensor values to the communication terminal 7 (step S1001). The communication terminal 7 performs processing on the sensor values collected from sensor group 8 (step S1002). Such processing may be for conforming the sensor values to the reception protocol of the server apparatus 2.

Subsequently, the communication terminal 7 transmits the sensor values to the server apparatus 2 (step S1003). The sensor values transmitted from the communication terminal 7 may be associated with information specifying the space in which each sensor is installed. This association may be performed by the communication terminal 7 or the space-specifying information may be pre-appended to the sensor values.

When the server apparatus 2 receives the sensor values via reception unit 271, the hierarchy unit 273 hierarchically processes the sensor values to generate hierarchical information (step S1004).

Processing by the hierarchy unit 273 will now be described. For example, when the sensor values indicate an indoor temperature below 23° C., the hierarchy unit 273 may classify the temperature as “low,” and when the sensor values are 26° C. or higher, classify the temperature as “high.” Further, when the indoor temperature is 23° C. or higher and below 26° C., the hierarchy unit 273 may classify the indicated environment as “appropriate.”

In addition, when the sensor values represent an indoor temperature, the hierarchy unit 273 may use terms, such as “hot,” “appropriate,” and “cool” instead of “high,” “appropriate,” and “low,” respectively.

Moreover, when the sensor values indicate humidity, and the humidity is below 50%, the hierarchy unit 273 may classify the humidity as “low,” and when the humidity is 65% or higher, classify the environment as “high.” When the humidity is 50% or higher and below 65%, the hierarchy unit 273 may classify the environment as “proper.”

Further, when the sensor values represent humidity, the hierarchy unit 273 may use terms, such as “humid,” “proper,” and “dry” instead of “high,” “appropriate,” and “low,” respectively.

Also, when the sensor values indicate a noise level, and the noise level is 70 dB or higher, the hierarchy unit 273 may classify the environment as “noisy,” and when the noise level is below 40 dB, classify the environment as “quiet.” When the noise level is 40 dB or higher and below 70 dB, the hierarchy unit 273 may classify the environment as “easy to converse.”

Once the hierarchical information is generated by the hierarchy unit 273 in the server apparatus 2, the storage control unit 274 associates the sensor values, the hierarchical information, and the space-specifying information, and stores them in the environmental information storage unit 240 (step S1005). The space-specifying information may include building ID, floor, area, and partition.

FIG. 11 is a second sequence diagram illustrating an operation of the information processing system. In FIG. 11, operations corresponding to user interactions on the administrator terminal apparatus 5 are described.

The operations corresponding to interactions on the administrator terminal apparatus 5 include storing characteristic information in the characteristic information storage unit 230 of the server apparatus 2 and displaying report information on the administrator terminal apparatus 5. These operations are independent and occur at separate timings.

First, the operation of storing characteristic information in the characteristic information storage unit 230 will be described. In the information processing system 1, when the control unit 530 of the administrator terminal apparatus 5 receives an operation to display the input screen for characteristic information (step S1101), the communication control unit 550 transmits a display request for the input screen to the server apparatus 2 (step S1102). Upon receiving this request, the server apparatus 2 uses transmission unit 272 to send a display instruction for the input screen to the administrator terminal apparatus 5 (step S1103).

When the administrator terminal apparatus 5 receives the display instruction, the display control unit 540 displays the input screen for the characteristic information (step S1104). Subsequently, the administrator terminal apparatus 5 transmits the characteristic information entered on the input screen to the server apparatus 2 (step S1105).

The server apparatus 2, via the storage control unit 274, verifies that the received characteristic information contains no deficiencies (step S1106), and then stores the input characteristic information in the characteristic information storage unit 230 (step S1107).

The above describes the operation of storing characteristic information. If, during verification at step S1106, it is found that the characteristic information contains inappropriate content, the server apparatus 2 may send an error notification to the administrator terminal apparatus 5 to prompt re-entry.

Next, the operation of displaying report information will be described. When the administrator terminal apparatus 5 receives an operation to select the space for which report information is to be displayed and to instruct its display (step S1108), it transmits a display request for the report information to the server apparatus 2 (step S1109). This display request includes information specifying the space to be the target of the report output and may also include information specifying the period for the output. Additionally, the display request need not be based solely on a user operation; for example, the administrator terminal apparatus 5 may periodically send display requests to update and display the report information at predetermined intervals.

When the server apparatus 2 accepts the display request, the prompt generation unit 275 generates a prompt requesting creation of report information for the space selected on the administrator terminal apparatus 5 (step S1110).

Specifically, the prompt generating unit 275 extracts, from the environmental information storage unit 240, environmental information collected during the analysis period from among the environmental information of the selected space, and includes the extracted environmental information in the prompt. In other words, the prompt generating unit 275 generates a prompt requesting an analysis of the environment of the selected space based on the environmental information collected during the analysis period from among the environmental information of the selected space. The prompt generated here may include analysis items included in the report information. The analysis items may be input, for example, in the administrator terminal device 5.

The prompt generated here may also include information indicating the period for which the report information is to be output. The information indicating the period for which the report information is to be output may be input in the administrator terminal device 5.

The prompt generated here may also be generated for each analysis item included in the report information, such as thermal comfort, air environment, and space evaluation. In this case, environmental information including sensor values related to each analysis item is included in the prompt.

The server device 2 transmits the prompt generated by the prompt generating unit 275 to the server device 3 through the transmitting unit 272 (step S1111). The large-scale language model stored in the storage unit 330 of the server device 3 outputs report information corresponding to the prompt received from the server device 2 (step S1112), and transmits the report information to the server device 2 through the communication control unit 340 (step S1113).

When the server device 2 receives the report information through the receiving unit 271, the storage control unit 274 stores the report information in the report storage unit 260 (step S1114). In addition, the server device 2 generates data for displaying a screen including the report information through the report creating unit 279 (step S1115), and transmits a display instruction to the administrator terminal device 5 (step S1116).

The administrator terminal device 5 displays a report screen including the report information through the display control unit 540 in response to the display instruction (step S1117). The above is the operation of displaying the report information.

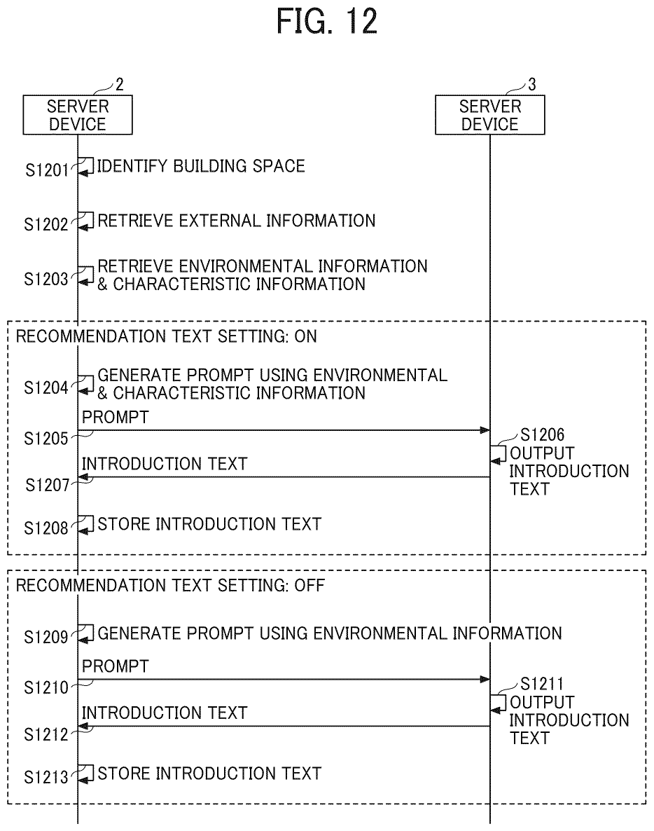

FIG. 12 is a third sequence diagram explaining the operation of the information processing system. FIG. 12 explains the operation in the case where the server device 2 periodically generates a prompt and acquires an introduction from the server device 3.

In the information processing system 1, the server device 2 identifies the space of the building from which the introduction is to be acquired (step S1201). Next, the server device 2 acquires external information from a server external to the information processing system 1 by the information acquisition unit 278 (step S1202). The external information acquired here may be, for example, weather information.

Next, the server device 2 acquires environmental information and characteristic information corresponding to the space of the building identified in step S1201 by the prompt generation unit 275 (step S1203).

The following processing from step S1204 to step S1208 is performed when the value of “recommended text setting” is set to “Yes” in the acquired characteristic information.

If a recommended text setting is set in the characteristic information, the prompt generation unit 275 generates a prompt including the environmental information, characteristic information, weather information, conditions for creating an introductory text, and a request for creating an introductory text (step S1204).

More specifically, the prompt generated here includes data (sensor values) associated with information on the installation position of the sensor (information identifying the selected space). In addition, the prompt generated here includes a condition (condition for creating an introductory text) that instructs the introductory text to include information recommended for use of the space.

In the one or more embodiments, by including, in the prompt, weather information acquired as external information, Server Apparatus 3 can output an introductory text tailored to the current weather conditions.

In the one or more embodiments, if the “Input Information” field in the characteristic information is empty, Prompt Generation Unit 275 need only generate a prompt that includes the environmental information and instructions to include in the introductory text any information recommended for use of the space.

Next, Server Apparatus 2 transmits the generated prompt to Server Apparatus 3 via Transmission Unit 272 (Step S1205). Server Apparatus 3 outputs an introductory text in response to the prompt using the large language model stored in Storage Unit 330 (Step S1206) and returns it to Server Apparatus 2 (Step S1207).

Upon receiving the introductory text via Reception Unit 271, Server Apparatus 2 stores, in Descriptive-Text-History Storage Unit 250, the introductory text together with the date and time of receipt and the space-identifying information determined in Step S1201, thereby associating these items as an entry in the introductory-text history (Step S1208).

The processing from Step S1209 through Step S1213 corresponds to the case where, in the acquired characteristic information, the “Recommended-Text Setting” value is “None.”

When the “Recommended-Text Setting” is “None,” Prompt Generation Unit 275 generates a prompt that includes the environmental information and instructions to include recommended-use information for the space in the introductory text (Step S1209). This prompt may also include the characteristic information.

Because the processing of Steps S1210 through S1213 in FIG. 12 is the same as that of Steps S1205 through S1208, the description is omitted.

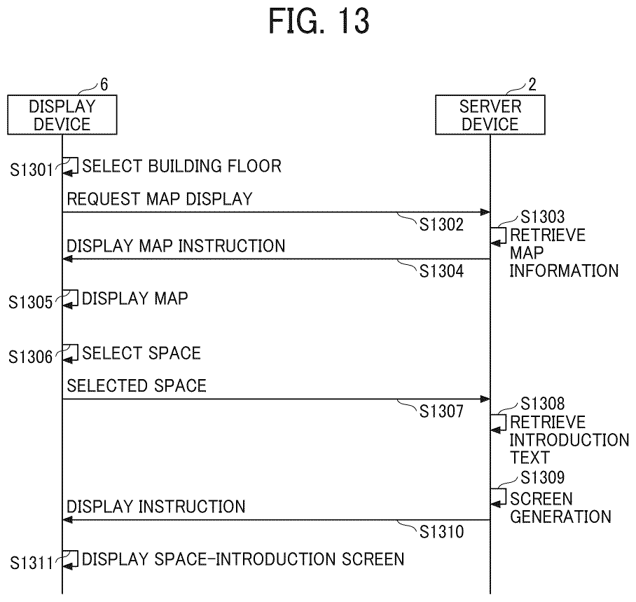

FIG. 13 is a fourth sequence diagram illustrating an operation in which, in response to a request from Terminal Apparatus 4, Server Apparatus 2 causes Display Apparatus 6 to display a screen containing an introductory text stored in Descriptive-Text-History Storage Unit 250. Display Apparatus 6 may be installed at an entrance to the building and initially present a list of floors.

In Information Processing System 1, when Display Apparatus 6 accepts a user operation to select a floor (Step S1301), Communication Control Unit 633 sends a display-request for the map information of the selected floor to Server Apparatus 2 (Step S1302).

Server Apparatus 2's Screen Generation Unit 276 refers to Characteristic-Information Storage Unit 230 to retrieve the map information for the selected floor and generates the data necessary to display a screen including that map (Step S1303). Transmission Unit 272 then sends a display instruction for the map to Display Apparatus 6 (Step S1304).

Upon receiving the display instruction, Display Apparatus 6's Display Control Unit 632 renders the floor map screen (Step S1305).

Next, Display Apparatus 6 accepts selection of a space on the floor map (Step S1306). In the one or more embodiments, the user may select an area or partition displayed on the map.

Alternatively, the floor-map screen may also present a list of space-selection conditions; the user's selection of one of these conditions may define the space to be introduced.

In that case, when Display Apparatus 6 accepts a space-condition selection, Server Apparatus 2 may refer to Environmental-Information Storage Unit 240 to identify, among the spaces on the selected floor, those satisfying the chosen condition, and select one such space as the “space to introduce.”

Thereafter, Display Apparatus 6's Communication Control Unit 633 notifies Server Apparatus 2 of the selected space-identifying information (e.g., Building ID, floor number, and space name) (Step S1307).

Upon receiving the space-identifying information, Server Apparatus 2's Screen Generation Unit 276 retrieves from Descriptive-Text-History Storage Unit 250 the introductory-text entry corresponding to that space having the latest timestamp (Step S1308). Screen Generation Unit 276 then generates data for a screen that includes the retrieved introductory text (Step S1309), and Output Unit 277 sends a display instruction for that screen to Display Apparatus 6 (Step S1310).

Display Apparatus 6 renders the introductory-text screen for the selected space in accordance with the display instruction (Step S1311).

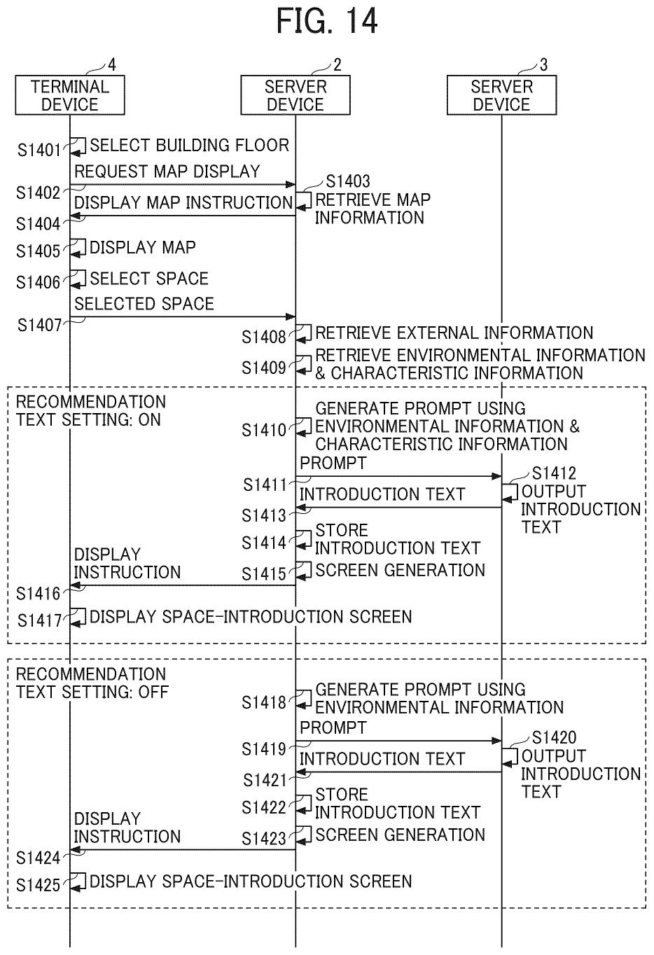

FIG. 14 is a fifth sequence diagram illustrating an operation in which, in response to a request from Terminal Apparatus 4, Server Apparatus 2 generates a prompt, obtains an introductory text from Server Apparatus 3, and displays a screen containing that text on Terminal Apparatus 4. In the example of FIG. 14, the user of Terminal Apparatus 4 may already be logged in and viewing a building-floor list.

The processing of Steps S1401 through S1407 in FIG. 14 is the same as that of Steps S1301 through S1307 in FIG. 13, except that Terminal Apparatus 4 takes the place of Display Apparatus 6. The description is therefore omitted.

Similarly, Steps S1408 through S1414 in FIG. 14 correspond to Steps S1202 through S1213 in FIG. 12, and the description is omitted.

When the introductory text is stored into Descriptive-Text-History Storage Unit 250 at Step S1414, Screen Generation Unit 276 generates data for the introductory-text screen (Step S1415), and Output Unit 277 sends the display instruction to Terminal Apparatus 4 (Step S1416). Terminal Apparatus 4 then displays the screen via its Display Control Unit 440.

Steps S1418 through S1422 in FIG. 14 correspond to Steps S1209 through S1213 in FIG. 12, and Steps S1423 through S1425 correspond to Steps S1415 through S1417; descriptions are omitted.

Although in the examples of FIGS. 13 and 14 the user selects a space directly on the displayed floor map, the invention is not limited thereto.

In the one or more embodiments, Server Apparatus 2 may, upon selection of a space condition from the map screen, generate a prompt including that condition, send it to Server Apparatus 3, and allow the AI to identify the space to introduce.

In the one or more embodiments, when a spatial condition is selected from a list of spatial conditions displayed together with a floor map, the server device 2 may generate a prompt including the selected spatial condition and transmit the prompt to the server device 3, so that the server device 3 may identify a space to be introduced by AI.

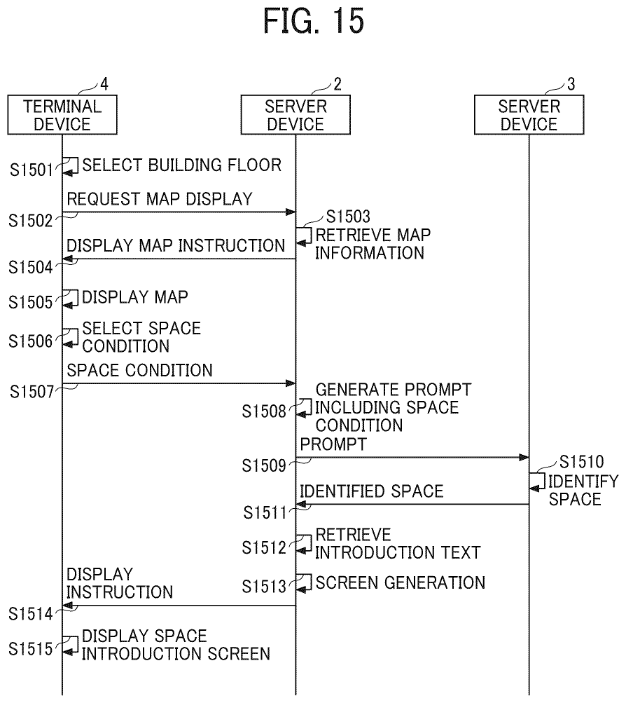

FIG. 15 is a sixth sequence diagram illustrating an operation in which, based on a space-condition selection on Terminal Apparatus 4, Server Apparatus 2 generates a prompt to identify the space to introduce.

The processing of Steps S1501 through S1505 in FIG. 15 corresponds to Steps S1401 through S1405 in FIG. 14 and is omitted. At Step S1505, Terminal Apparatus 4 displays a screen including the floor map and space-condition list.

When Terminal Apparatus 4 accepts a space-condition selection (Step S1506), it sends the selected condition to Server Apparatus 2 (Step S1507).

Upon receiving the selected condition via Reception Unit 271, Server Apparatus 2's Prompt Generation Unit 275 generates a prompt that includes the selected condition and, optionally, the environment information of all spaces (areas or partitions) displayed on the floor map (S1508). Alternatively, the prompt need only include the hierarchical information for all such spaces. The Server Apparatus 2 sends the generated prompt to the Server Apparatus 3 (S1509).

Server Apparatus 3, retrieves the prompt and in accordance with the prompt, identifies the space to introduce (Step S1510) and returns information indicating that identified space to Server Apparatus 2 (Step S1511).

Upon identifying the space, Server Apparatus 2 retrieves from Descriptive-Text-History Storage Unit 250 the most recent introductory text for that space (Step S1512) and proceeds with the same processing as in FIG. 13, Steps S1308-S1311.

Alternatively, upon receiving the space-identifying information at Step S1511, Server Apparatus 2 may, via Prompt Generation Unit 275, retrieve the characteristic and environmental information for the identified space and generate a prompt requesting creation of an introductory text for that space.

In other words, after Step S1511 in FIG. 15, Server Apparatus 2 may perform the processing of FIG. 14, Steps S1408-S1425, to request and display a newly generated introductory text.

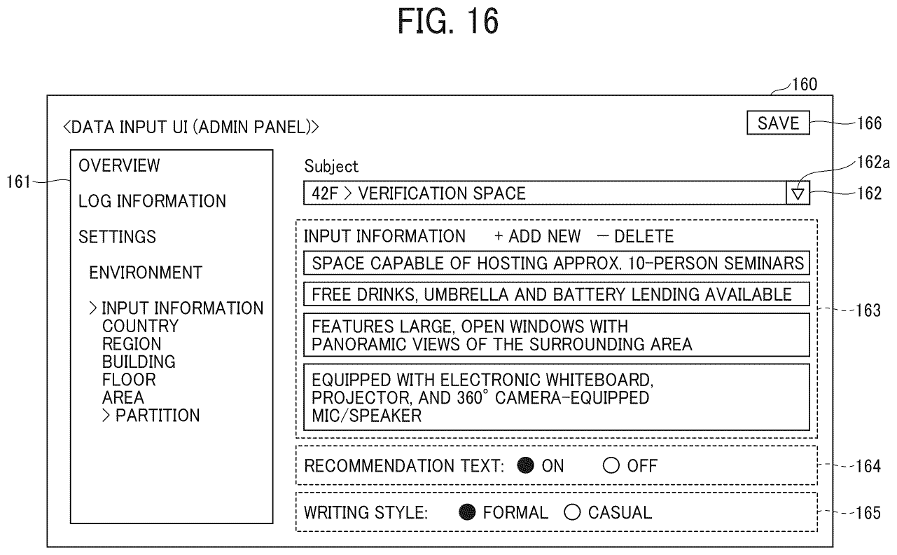

Next, with reference to FIGS. 16-21, examples of screens displayed by Information Processing System 1 of the one or more embodiments will be described.

FIG. 16 illustrates an example of the characteristic-information input screen. Screen 160, shown in FIG. 16, is displayed on Administrator Terminal Apparatus 5 in Step S1104 of FIG. 11.

Screen 160 includes a display region 161, selection field 162, input field 163, selection fields 164 and 165, and operation button 166.

Display region 161 shows information about the space for which characteristic information is to be entered. In the example of FIG. 16, it indicates that the target space is a partition within an area.

Selection field 162 allows the administrator to specify which space the characteristic information applies to. For example, pressing the pull-down button 162a may display a list of all spaces in the building.

The list of spaces may pair each floor with its space names. In FIG. 16, “Verification Space” on the 42nd floor has been selected.

Input field 163 is where free-form information is entered. Selection field 164 toggles whether “recommended text” should be included (“Yes” or “No”), and selection field 165 selects the text style (“Polite” or “Casual”).

Operation button 166 submits the entered data to Server Apparatus 2 for storage in Characteristic-Information Storage Unit 230.

In this way, by presenting screen 160 on the administrator's terminal, the administrator can specify the content, length, and style of the introductory text for each space.

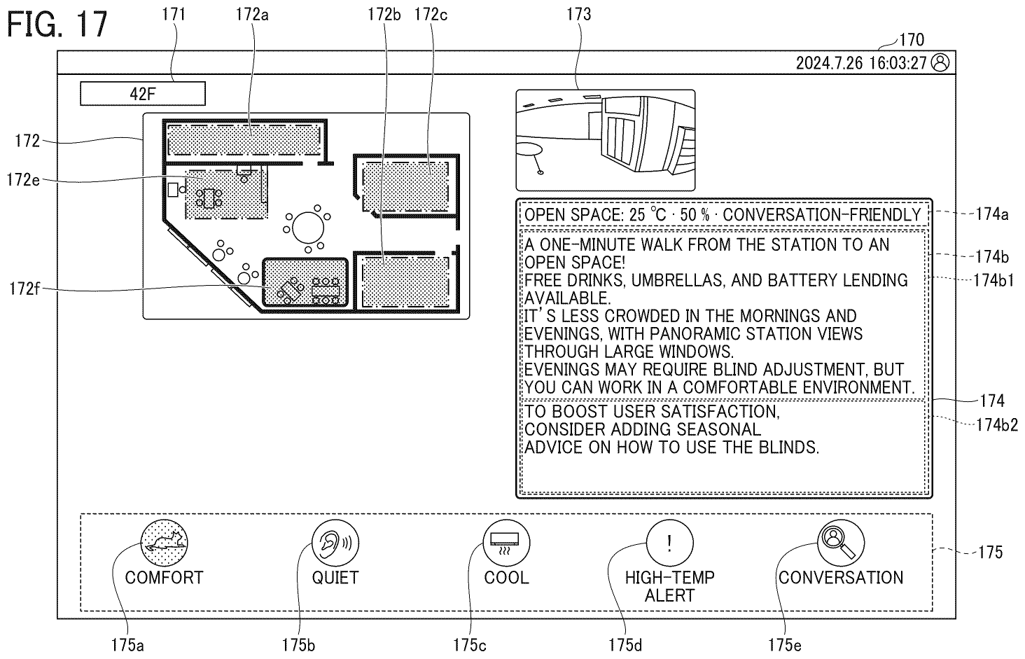

FIG. 17 illustrates a first example of the introduction screen displayed on Terminal Apparatus 4. Screen 170 in FIG. 17 is shown in Step S1417 of FIG. 14. In this example, the selected space is the Open Space, the “recommended text” setting is “Yes,” and the text style is “Polite.”

Screen 170 includes display regions 171, 172, 173, 174, and 175. Display region 171 shows the floor of the selected space. Display region 172 shows a floor map of that floor. In the example, the map of the 42nd floor of the building indicates four areas, three of which have images 172a, 172b, and 172c. One of those areas contains two partitions, shown by images 172e and 172f.

Images 172a, 172b, 172c, 172e, and 172f correspond to subdivided spaces on the floor.

When any of these images is selected, the corresponding space is identified and its introductory text displayed. In FIG. 17, image 172f is highlighted to indicate the Open Space has been selected.

Display region 173 shows a live image of the floor captured by one of the area's imaging devices. This enables users to see current occupancy.

If each area has its own camera, region 173 can update to show the image for the selected area.

Display region 174 shows the space's name and part of its environmental information in sub-region 174a, and the full introductory text in sub-region 174b.

In the following description, image 172b denotes the “Shared Area” and image 172f denotes the “Open Space” as in FIG. 6.

Region 174a displays a portion of the Open Space's environmental data. Region 174b displays the “Polite” introductory text, which includes both the administrator-entered input message 174b1 and the system's recommended-use message 174b2.

Display region 175 lists selectable space-condition icons—for example, “Comfortable,” “Quiet,” “Cool,” “High-Temperature Alert,” and “Conversation-Friendly”—with icons 175a-175e.

If an icon is selected, Server Apparatus 2 refers to all hierarchical environmental data in Environmental-Information Storage Unit 240 for that floor and identifies the space satisfying the chosen condition, then highlights its image.

For example, if icon 175b (“Quiet”) is chosen, the server selects the floor space with the lowest noise sensor reading and highlights its image.

If icon 175d (“High-Temperature Alert”) is chosen, the server selects all spaces above the temperature threshold and highlights their images on the floor map.

If icon 175e (“Conversation-Friendly”) is chosen, the server selects and highlights the space with noise levels conducive to conversation.

Thus, users may select a space directly on the map or via a condition icon to view its introduction.

Moreover, upon icon selection, Server Apparatus 2 may generate a prompt including the selected condition and transmit it to Server Apparatus 3; upon AI's response, it may highlight the AI-identified space.

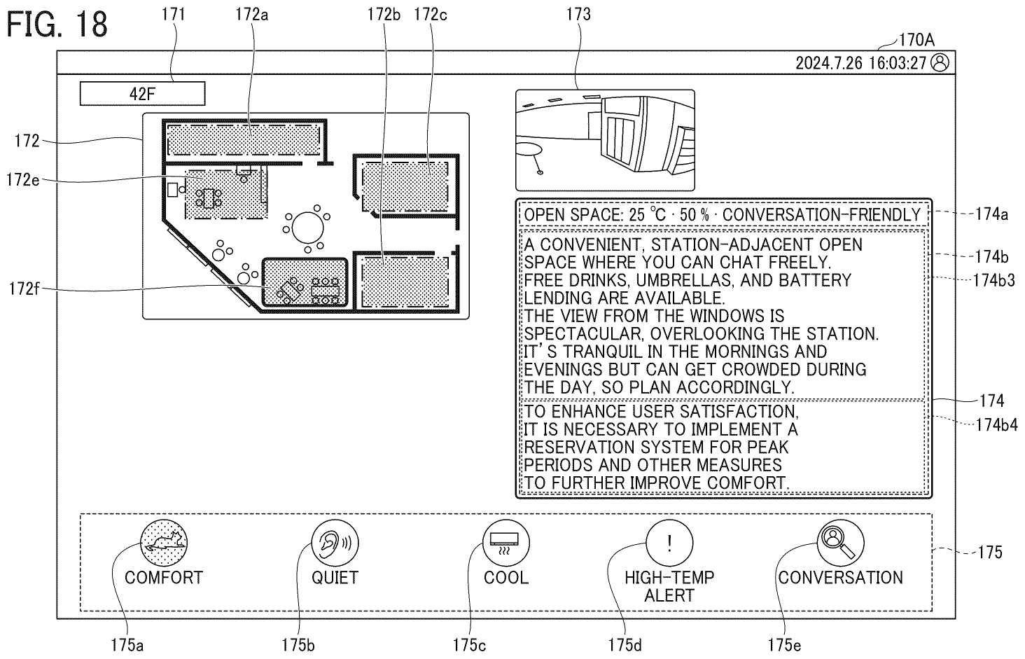

FIG. 18 illustrates a second example of the introduction screen, screen 170A, displayed on Terminal Apparatus 4 in Step S1417 of FIG. 14.

In this example, the Open Space's characteristic information has “recommended text” set to “Yes” and “Casual” style selected. Consequently, region 174b shows a more casual-tone introductory text.

Region 174b includes both the administrator's input message 174b3 and the system's recommendation message 174b4 in the casual style.

Thus, the one or more embodiments can present an introductory text that combines the space's environmental data, the administrator's characteristics, and recommended-use suggestions in the selected style.

According to the one or more embodiments, by selecting a space, the user can view details of each subdivided space within the floor. Furthermore, the user can view each space's characteristic information and any recommended messages for using that space.

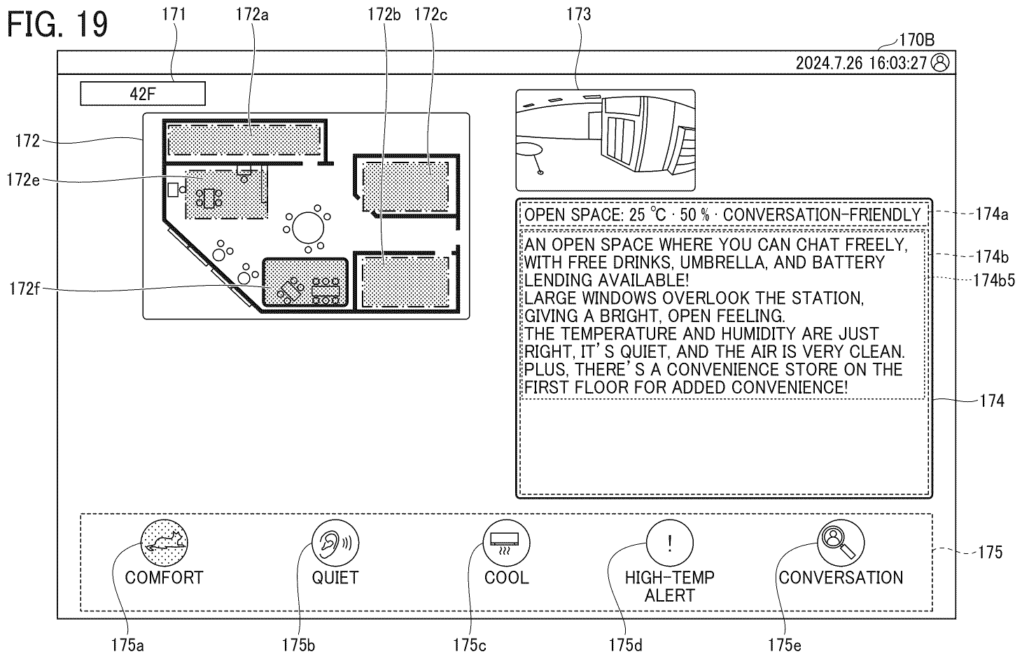

FIG. 19 is a third example of an introduction screen displayed on Terminal Apparatus 4. Introduction screen 170B shown in FIG. 19 corresponds to Step S1425 of FIG. 14. In this example, the Open Space's characteristic information has “Recommended-Text Setting” set to “None” and “Text Style” set to “Polite.”

Accordingly, the introductory text in display region 174b consists only of the input-information message 174b5 specified in the Open Space's characteristic information.

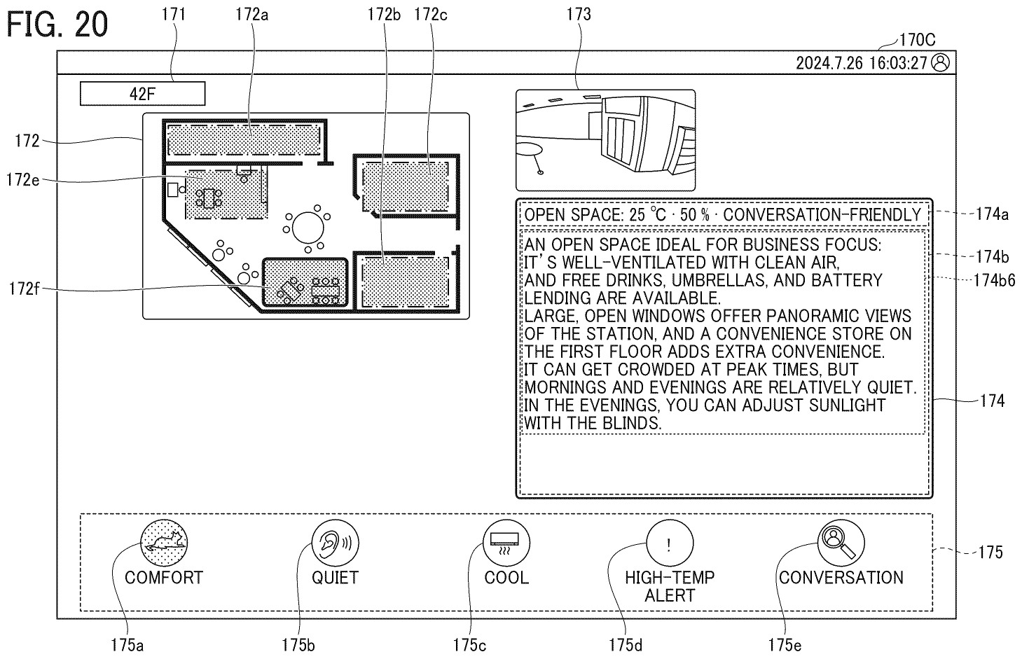

FIG. 20 is a fourth example of an introduction screen, screen 170C, also at Step S1425 of FIG. 14. In this example, the Open Space's characteristic information has “Recommended-Text Setting” set to “None” and “Text Style” set to “Casual.”

Thus, the introductory text in display region 174b consists only of the input-information message 174b6 from the Open Space's characteristic information.

As shown, the one or more embodiments allows the content and tone of the introductory text to vary according to the characteristic-information settings-enabling customization based on customer preferences or usage scenarios (e.g., shortening the text).

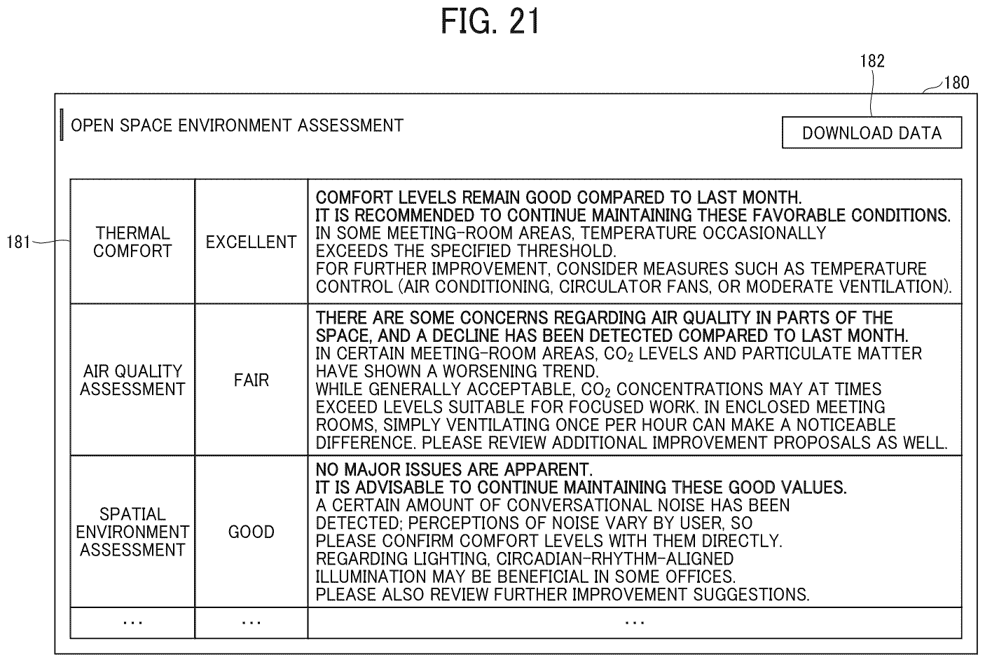

FIG. 21 is a first example of a report screen. Report screen 180 in FIG. 21 is displayed on Administrator Terminal Apparatus 5 at Step S1117 of FIG. 11.

In FIG. 21, the Open Space (indicated by image 171f in display region 171 of FIG. 17) has been selected as the space whose report information is to be displayed.

Report screen 180 includes display region 181 and operation button 182. Display region 181 shows report information output from Server Apparatus 3, including analysis items, analysis results, and environmental evaluation based on those results.

Operation button 182 allows the user to download the report information shown in display region 181 to Administrator Terminal Apparatus 5. When button 182 is pressed, Server Apparatus 2 sends the displayed report information to Administrator Terminal Apparatus 5 for download.

By providing the administrator with this report screen, changes in the space's environment over time can be monitored.

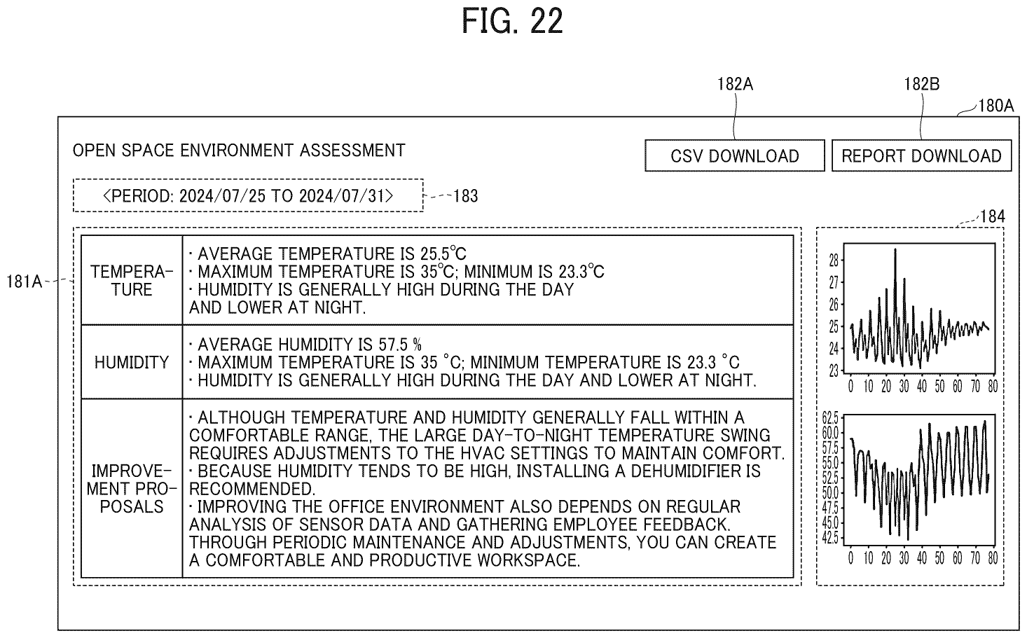

FIG. 22 is a second example of a report screen, screen 180A, at Step S1117 of FIG. 11.

Report screen 180A displays, in addition to the report-target space, an input field for specifying the time period over which the report should cover. The resulting report information may alternatively be output to Display Apparatus 6.

Screen 180A comprises display region 181A, operation buttons 182A and 182B, and display regions 183 and 184. Display region 181A shows text-based report information from Server Apparatus 3. Display region 183 shows the user-specified time period. Display region 184 presents a graph of sensor-value variations collected during that period.

In other words, display region 181A displays the textual analysis results from Server Apparatus 3, while display region 184 shows the corresponding sensor-value trends. The graph in 184 may be generated by Server Apparatus 3 and sent as part of the report, or alternatively generated by Report Creation Unit 279 of Server Apparatus 2 from stored sensor data in Environment Information Storage Unit 240.

For example, on screen 180A the report may include analysis results on temperature, humidity, and suggested measures to improve the environment during the specified period for the selected space.

While FIG. 22 shows a line graph in display region 184, other graph types (bar charts, pie charts, etc.) could be selected via Administrator Terminal Apparatus 5.

Operation button 182A downloads the graph data from display region 184 to the administrator terminal, and button 182B downloads the report text from display region 181A. Optionally, pressing 182B can download both the text and the graph together.

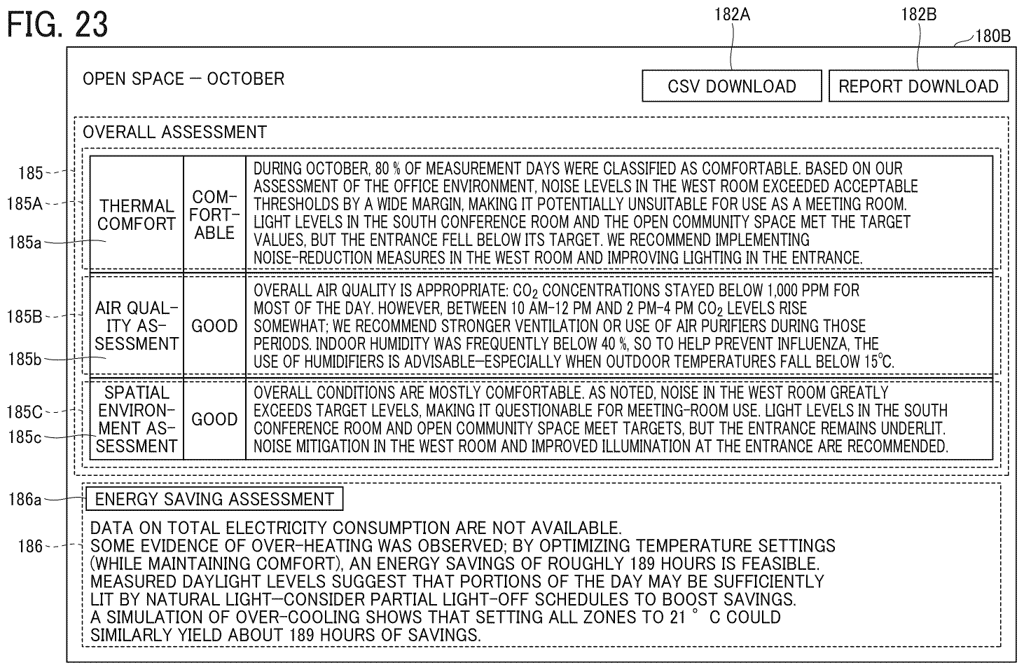

FIG. 23 is a third report-screen example, screen 180B, displayable at Step S1117 of FIG. 11.

Screen 180B includes display regions 185 and 186 with operation buttons 182A and 182B. Regions 185 and 186 each contain report snippets. Specifically, region 185 subdivides into 185A, 185B, and 185C—each paired with a detail-button (185a, 185b, 185c, respectively).

Display region 185A shows thermal-comfort information; pressing button 185a transitions to detailed screen 190A.

Region 185B shows air-quality evaluation information; button 185b leads to detail screen 190B.

Region 185C shows spatial-evaluation information; button 185c leads to detail screen 190C.

Display region 186 shows estimated power-consumption information for the space. Power estimates may be based on internal/external temperature and humidity, or measured directly by a power sensor in Sensor Group 8, with values stored alongside other environmental data.

Button 186a in region 186 transitions to detail screen 190D for power-consumption details.

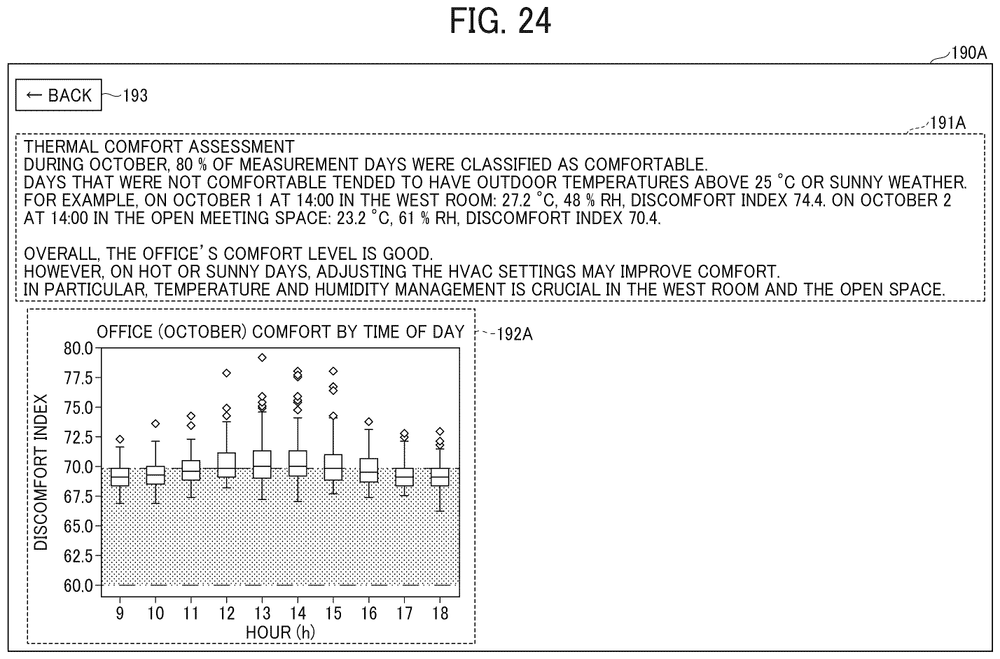

FIG. 24 is a first example of a detail screen. Detail screen 190A appears on Administrator Terminal Apparatus 5 when button 185a is selected on screen 180B of FIG. 23.

Detail screen 190A comprises display regions 191A and 192A plus back-button 193. Region 191A shows detailed thermal-comfort analysis text; region 192A shows a graph of the sensor-value trends used for that analysis. Button 193 returns the user to report screen 180B. The thermal-comfort analysis uses readings from temperature, humidity, and barometric-pressure sensors, and the accompanying text and graph are received from Server Apparatus 3 in response to the analysis prompt at Step S1113 of FIG. 11.

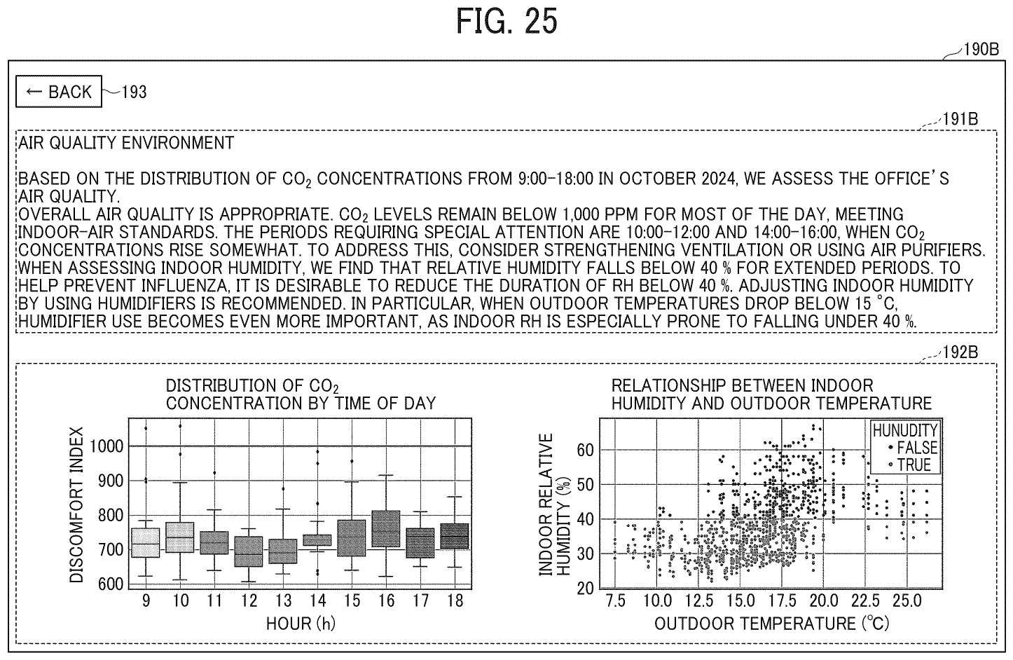

FIG. 25 is a second example of a detailed screen. Detailed screen 190B shown in FIG. 25 is displayed on Administrator Terminal Apparatus 5 when operation button 185b is selected on report screen 180B of FIG. 23.

Detailed screen 190B includes display regions 191B and 192B, and operation button 193. Display region 191B shows text data indicating detailed analysis results for the air environment. Display region 192B shows a graph of the sensor-value fluctuations used in that air-environment analysis.

The sensors whose readings are used for the air-environment analysis may include, for example, a CO₂ concentration sensor and a humidity sensor installed in the space. The text data and graph in detailed screen 190B are part of the report information received from Server Apparatus 3 in response to the prompt of Step S1113 in FIG. 11, which included the relevant environmental information.

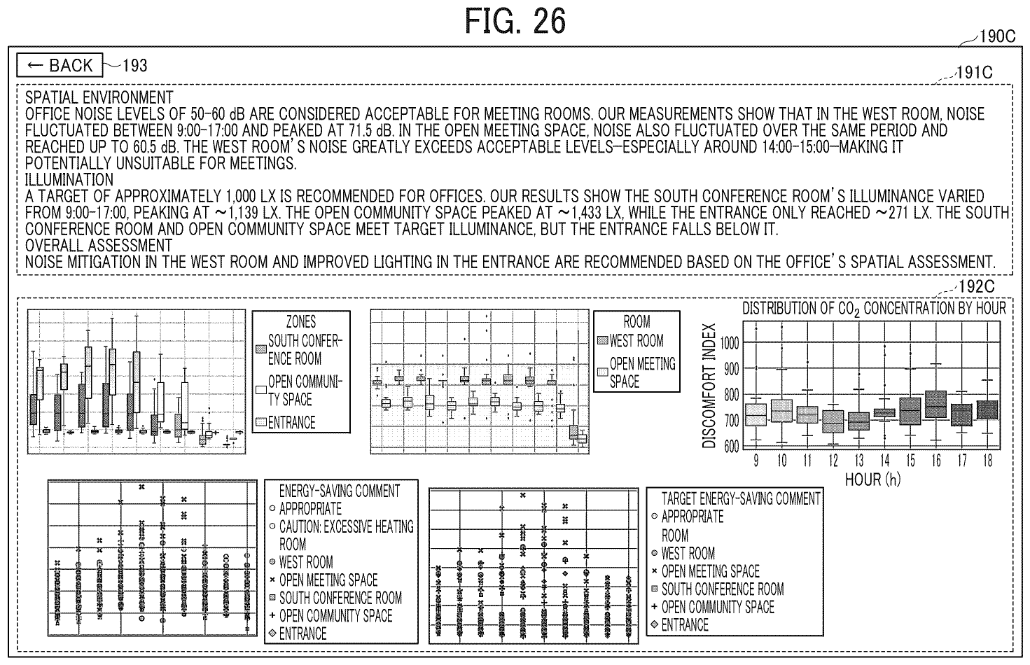

FIG. 26 is a third example of a detailed screen. Detailed screen 190C shown in FIG. 26 is displayed on Administrator Terminal Apparatus 5 when operation button 185c is selected on report screen 180B of FIG. 23.

Detailed screen 190C includes display regions 191C and 192C, and operation button 193. Display region 191C shows text data indicating detailed analysis results for the spatial environment. Display region 192C shows a graph of the sensor-value fluctuations used in that spatial-environment analysis.

Note: The sensors whose readings are used for the spatial-environment analysis may include noise, solar-irradiance, barometric-pressure, and illuminance sensors, as well as an occupancy-detection imaging device. The text data and graph in detailed screen 190C are part of the report information received from Server Apparatus 3 in response to the prompt of Step S1113 in FIG. 11.

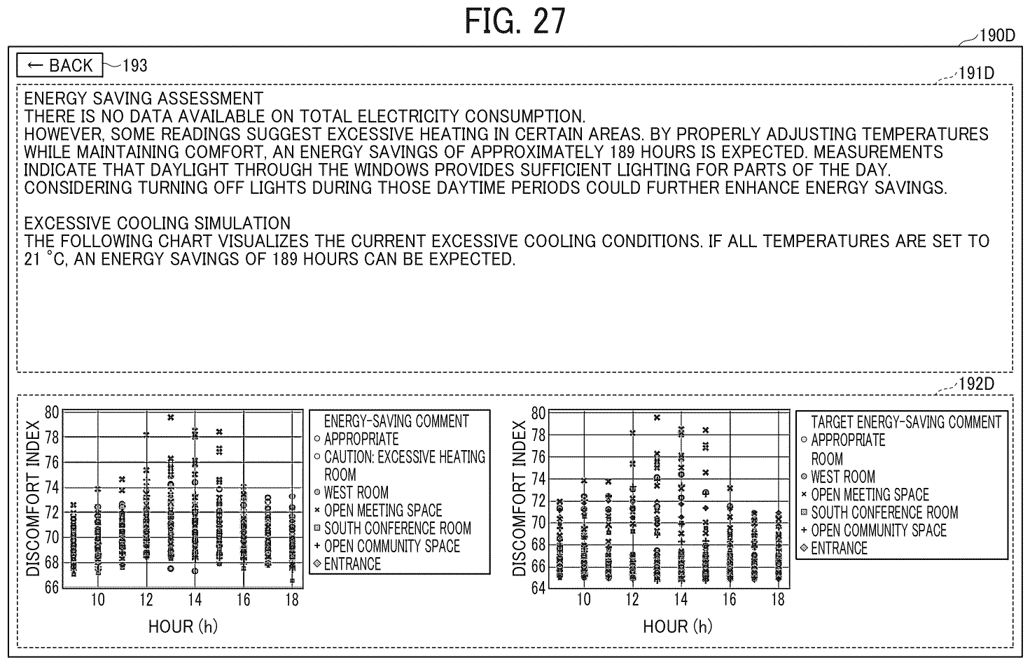

FIG. 27 is a fourth example of a detailed screen. Detailed screen 190D shown in FIG. 27 is displayed on Administrator Terminal Apparatus 5 when operation button 185d is selected on report screen 180B of FIG. 23.

Detailed screen 190D includes display regions 191D and 192D, and operation button 193. Display region 191D shows text data indicating detailed analysis results for power consumption, which may include proposals for reducing energy usage.

Display region 192D shows a graph of the sensor-value fluctuations used in the power-consumption analysis. This graph may depict, for example, the amount of energy consumed over the specified period and forecasted future consumption. Note: The sensors whose readings are used for the power-consumption analysis may include illuminance, temperature, humidity sensors, and an energy-meter sensor. The text data and graph in detailed screen 190D are part of the report information received from Server Apparatus 3 in response to the prompt of Step S1113 in FIG. 11.

As described above, in the one or more embodiments, various analyses based on sensor readings can be performed for the target space, and the results displayed.

The above embodiment may be applied, for example, to an office. In such a case, office workers can check the environmental information of each space upon arriving or departing. Thus, users can select their workspace according to personal preference and the space's environment.

The one or more embodiments may also be implemented in facilities that rent out spaces-such as meeting rooms or workspaces in a shared-office. In that case, presenting the environmental-information screen to rental users allows them to select their preferred space.

Each function of the above-described embodiments can be implemented by one or more “processing circuits.” As used herein, a “processing circuit” may be a processor programmed to execute the functions in software, an ASIC, DSP, FPGA, or conventional hardware module configured to perform the described functions.

The devices described herein are examples of one computing environment for practicing the invention.

In one embodiment, Server Apparatus 2 may comprise a server cluster of multiple computing devices that communicate via any link (e.g., network or shared memory) to perform the disclosed processes. Similarly, the information processing devices of System 1 may each comprise multiple interconnected computing devices.

Moreover, Server Apparatus 2 may distribute the disclosed process steps among various units in various combinations. Functions carried out by a particular unit may instead be performed by any computing device in the server cluster. Likewise, elements of Server Apparatus 2 may be consolidated or distributed across multiple devices.

Server Apparatus 2 may be any device with communication capability, such as a projector (PJ), interactive whiteboard (IWB), digital signage, HUD, industrial machinery, imaging device, audio-capture device, medical equipment, network appliance, connected car, PC, smartphone, tablet, game console, PDA, digital camera, wearable PC, or desktop PC.

1. A server apparatus for communicating with a device that generates artificial intelligence (AI) based responses, comprising:
processing circuitry configured to:
receive real-time data measured by a plurality of sensors installed in a predetermined physical space,
generate, based on the real-time data, a prompt including environmental information based on the data, the prompt requesting creation of descriptive text introducing the predetermined physical space for user selection,
transmit, the generated prompt to the device,
receive, from the device, the descriptive text generated by an AI model in response to the prompt, and
output, to a display device, a user interface screen displaying the descriptive text and a map of the predetermined physical space, the user interface screen enabling a user to select the predetermined physical space based on the environmental information.

2. The server apparatus of claim 1, wherein the environmental information describes conditions of the predetermined physical space, and
wherein the outputting the screen based on the descriptive text generated under those conditions.

3. The server apparatus of claim 2, wherein the conditions specify inclusion of actions or suggestions to improve user satisfaction in the descriptive text.

4. The server apparatus of claim 2, wherein the conditions specify inclusion of messages prompting user action in the descriptive text.

5. The server apparatus of claim 2, wherein the conditions specify inclusion of recommended activities or behaviors for the predetermined physical space in the descriptive text.

6. The server apparatus of claim 1, wherein the outputting includes generating, for the user interface screen, the descriptive text corresponding to a user-selected physical space among a plurality of physical spaces in the predetermined physical space, the user interface screen including a floor map highlighting the user-selected physical space and real-time environmental conditions derived from the plurality of sensors.

7. The server apparatus of claim 1, wherein the predetermined physical space is selected via a user operation.

8. The server apparatus of claim 1, wherein the predetermined physical space is selected based on a user-input space condition received via the user interface screen, the space condition specifying at least one environmental parameter derived from the real-time data, and
wherein the processing circuitry is further configured to identify the predetermined physical space by matching the space condition to the environmental information.

9. The server apparatus of claim 8, wherein generating includes, a prompt instructing AI-based selection of the predetermined physical space based on the user-input condition, and
wherein the processing circuitry outputs information identifying the space selected by the device.

10. The server apparatus of claim 1, wherein the outputting, a screen for inputting information about the predetermined physical space.

11. The server apparatus of claim 1, wherein the plurality of sensors further includes a humidity sensor, a carbon-dioxide concentration sensor, a solar-irradiance sensor, a barometric-pressure sensor, and an illuminance sensor.

12. The server apparatus of claim 1, wherein the prompt further includes external information acquired from an external server.

13. The server apparatus of claim 1, wherein the processing circuitry is further configured to convert the real-time data into hierarchical information by classifying sensor values into human-readable categories based on predefined thresholds, and
wherein the prompt includes the hierarchical information to generate the descriptive text for the user interface screen.

14. The server apparatus of claim 1, wherein the prompt includes information about the installation locations of the plurality of sensors.

15. The server apparatus of claim 1, wherein the plurality of sensors further includes a human detection sensor, and the real-time data includes information indicating the presence or absence of a person.

16. The server apparatus of claim 1, wherein the processing circuitry is configured to:
generate, based on the real-time data measured by the plurality of sensors, a prompt requesting an AI-based analysis of environmental conditions of the predetermined physical space over a specified time period,
receive, from the device, analysis results generated by the AI model in response to the prompt, and
create a report for display on the user interface screen, the report including the analysis results and a graphical representation of sensor value trends for optimizing the predetermined physical space.

17. The server apparatus of claim 16, wherein, the report may include analysis results on temperature, humidity, and suggested measures to improve an environment during the specified period for a selected space among the predetermined physical space.

18. An information processing system comprising:
the server apparatus of claim 1;
a plurality of sensors installed in a predetermined physical space, the plurality of sensors including at least a temperature sensor and a noise sensor configured to measure real-time environmental data; and
a display apparatus communicable with the server apparatus, the display apparatus comprising a display control circuitry configured to render the user interface screen output by the server apparatus, the user interface screen displaying the descriptive text, a floor map of the predetermined physical space, and real-time environmental conditions to enable user selection of the predetermined physical space.

19. A method of communicating with an artificial intelligence (AI) based response device, comprising:
receiving, at a server apparatus, real-time data measured by a plurality of sensors installed in a predetermined physical space, the plurality of sensors including at least a temperature sensor and a noise sensor;
generating, at the server apparatus, a prompt that includes environmental information based on the real-time data and that requests creation of descriptive text introducing the predetermined physical space for user selection in the free-address office environment;
transmitting the prompt to the AI based response device;
receiving, from the AI-based response device, the descriptive text generated by an AI model; and
outputting, to a display apparatus, a user interface screen displaying the descriptive text and a floor map of the predetermined physical space, the user interface screen enabling a user to select the predetermined physical space based on the environmental conditions.

20. An information processing system comprising:
a plurality of sensors installed in a predetermined physical space within an office environment, the plurality of sensors including at least a temperature sensor and a noise sensor configured to measure real-time environmental data;
a server apparatus communicable with a device that generates artificial intelligence (AI)-based responses, the server apparatus comprising processing circuitry configured to:
receive the real-time environmental data measured by the plurality of sensors;
generate, based on the real-time environmental data, a prompt including environmental information describing conditions of the predetermined physical space, the prompt requesting creation of descriptive text introducing the predetermined physical space for user selection in the office environment;
transmit the generated prompt to the device;
receive, from the device, the descriptive text generated by an AI model in response to the prompt; and
output a user interface screen displaying the descriptive text corresponding to a user-selected physical space among a plurality of physical spaces in the office environment,
the user interface screen including a floor map highlighting the user-selected physical space and real-time environmental conditions derived from the plurality of sensors; and
a display apparatus communicable with the server apparatus, the display apparatus comprising a display control circuitry configured to render the user interface screen output by the server apparatus, the user interface screen enabling a user to select the predetermined physical space based on the environmental conditions.
